(19) United States
(12) Patent Application Publication
(10) Pub. No.: US 2026/0220008 A1
(43) Pub. Date: Jul. 30, 2026

(54) DECENTRALIZED SECURITY MONITORING SYSTEM

(71) Applicant: Alarm.com Incorporated, Tysons, VA (US)

(72) Inventors: Joshua Yan Hang Ng, Tysons, VA (US); Kyle Rankin Johnson, Falls Church, VA (US); Abraham Joseph Kinney, Vienna, VA (US); Daniel Todd Kerzner, McLean, VA (US)

(21) Appl. No.: 19/442,259

(22) Filed: Jan. 7, 2026

Related U.S. Application Data
(60) Provisional application No. 63/749,166, filed on Jan. 24, 2025.

(51) Int. Cl. G06F 11/22; G06F 11/30

(52) U.S. Cl. CPC G06F 11/2221; G06F 11/3058

(57) ABSTRACT

Methods, systems, and apparatus, including computer programs encoded on computer storage media, for decentralized property security monitoring. One of the methods includes maintaining a first device of a set of devices for a property as a lead device, wherein maintaining the first device as the lead device causes the first device to: collect sensor data generated by the set of devices; generate event information using the sensor data; and communicate the event information to one or more computers; while maintaining the first device as the lead device, detecting a failure of the first device; selecting, from the set of devices excluding the first device, a second device; and assigning the second device as the lead device.

### CROSS-REFERENCE TO RELATED APPLICATIONS

This application claims the benefit of U.S. Provisional Patent Application No. 63/749,166 filed January 24, 2025, which is hereby incorporated by reference in its entirety.

### BACKGROUND

Monitoring systems can include multiple sensors. Some examples of sensors can include cameras, motion detectors, smoke detectors, and breaking glass detectors.

### SUMMARY

In general, one innovative aspect of the subject matter described in this specification can be embodied in methods that include the actions of maintaining a first device of a set of devices for a property as a lead device. Maintaining the first device as the lead device causes the first device to: collect sensor data generated by the set of devices; generate event information using the sensor data; and communicate the event information to one or more computers. The actions include, while maintaining the first device as the lead device, detecting a failure of the first device; selecting, from the set of devices excluding the first device, a second device; and assigning the second device as the lead device.

Other implementations of this aspect include corresponding computer systems, apparatus, computer program products, and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The foregoing and other implementations can each optionally include one or more of the following features, alone or in combination.

In some implementations, the method can include detecting the failure of the first device by determining that communication capabilities between the first device and at least one of the one or more computers do not satisfy one or more capability criteria.

In some implementations, the method includes determining that communication capabilities between the first device and the one or more computers do not satisfy one or more capability criteria based on lack of receipt of communication from the first device.

In some implementations, the method includes determining that communication capabilities between the first device and the one or more computers do not satisfy the one or more capability criteria based on failure of a test communication.

In some implementations, the method includes detecting the failure of the first device based on receiving a communication from another device of the set of devices indicating failure of the first device.

In some implementations, the method includes detecting the failure of the first device based on detecting a distress signal from the first device.

In some implementations, the method includes notifying the other devices of the assignment of the second device as the lead device.

In some implementations, each device in the set of devices includes a sensing component, a communication component, and a processing component.

In some implementations, the processing component of at least some devices from the set of devices can execute a security application that can analyze sensor data from a plurality of different types of sensors.

In some implementations, the sensing component includes a camera, a motion detector, a smoke detector, a proximity detector, or a contact detector.

In some implementations, the set of devices communicate with each other through one or more wireless communication protocols.

In some implementations, maintaining the first device as the lead device includes sending an instruction to the first device to cause the first device to collect and process the sensor data from other devices in the set of devices.

In some implementations, selecting the second device uses data indicating one or more attributes of the second device.

In some implementations, the method includes selecting the second device using one or more of: a predetermined hierarchy of devices or device types; information indicating a connectivity level of the second device and connectivity levels of other devices of the set of devices; or information indicating a power level of the second device and power levels of other devices of the set of devices.

In some implementations, the set of devices includes two or more devices.

In general, one innovative aspect of the subject matter described in this specification can be embodied in methods that include the actions of transmitting, to a first device of a set of devices for a property and from a second device of the set of devices, sensor data generated by the second device. The first device is a lead device of the set of devices. The actions include determining, by the second device, to become the lead device of the set of devices based on a predicted failure of the first device; and in response to determining to become the lead device of the set of devices based on the predicted failure of the first device, configuring, by the second device, the second device as the lead device to cause the second device to: collect sensor data generated by at least some of the set of devices; generate event information using the sensor data; and communicate the event information to one or more computers.

Other implementations of this aspect include corresponding computer systems, apparatus, computer program products, and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The foregoing and other implementations can each optionally include one or more of the following features, alone or in combination.

In some implementations, determining to become the lead device of the set of devices includes: detecting the predicted failure of the first device; and self-assigning the second device as the lead device.

In some implementations, determining to become the lead device of the set of devices includes receiving an instruction to become the lead device.

In some implementations, the method includes receiving the instruction from one or more computers.

In some implementations, the method includes receiving the instruction from another device of the set of devices.

In some implementations, the method includes: collecting the sensor data generated by the at least some of the set of devices; generating the event information using the sensor data; and communicating the event information using the sensor data.

In some implementations, the method includes: after becoming the lead device, performing a discovery process to determine a status of one or more devices from the set of devices.

In some implementations, the method includes: detecting the predicted failure of the first device; and transmitting, to the one or more computers, an indication of the predicted failure of the first device.

In some implementations, detecting the predicted failure of the first device includes determining that communication capabilities between the first device and the second device do not satisfy one or more capability criteria.

In some implementations, the method includes determining that communication capabilities between the first device and the second device do not satisfy the one or more capability criteria based on lack of receipt of communication from the first device.

In some implementations, the method includes determining that communication capabilities between the first device and the second device do not satisfy the one or more capability criteria based on failure of a test communication.

In some implementations, the method includes determining that communication capabilities between the first device and the second device do not satisfy the one or more capability criteria based on receiving a communication from another device of the set of devices indicating failure of the first device.

In some implementations, the method includes determining that communication capabilities between the first device and the second device do not satisfy the one or more capability criteria based on detecting a distress signal from the first device.

In some implementations, the distress signal is encoded with information indicating a type of failure.

In some implementations, the method includes determining that communication capabilities between the first device and the second device do not satisfy the one or more capability criteria based on determining that a bandwidth available for the first device does not satisfy a threshold bandwidth.

In some implementations, the method includes determining that communication capabilities between the first device and the second device do not satisfy the one or more capability criteria based on predicting that the first device lost power.

In some implementations, the method includes collecting sensor data that was generated prior to the failure of the first device; and determining a predicted cause of failure of the first device.

In some implementations, the method includes sending information indicating the predicted cause of the failure of the first device to the one or more computers.

In some implementations, the method includes transmitting a notification to at least some devices of the set of devices notifying the devices of the second device becoming the lead device in response to determining to become the lead device of the set of devices based on the predicted failure of the first device.

In some implementations, determining, by the second device, to become the lead device of the set of devices uses data indicating one or more attributes of the second device.

In some implementations, the method includes determining, by the second device, to become the lead device of the set of devices using one or more of: a predetermined hierarchy of devices or device types; information indicating a connectivity level of the second device and connectivity levels of other devices of the set of devices; or information indicating a power level of the second device and power levels of other devices of the set of devices.

In some implementations, transmitting the sensor data to the first device is responsive to receiving a notification that the first device is the lead device.

In some implementations, each device includes a sensing component, a communication component, and a processing component.

In some implementations, the processing component of at least some devices from the set of devices can execute a security application that can analyze sensor data from a plurality of different types of sensors.

In some implementations, the sensing component includes a camera, a motion detector, a smoke detector, a proximity detector, or a contact detector.

In some implementations, the set of devices communicate with each other through one or more wireless communication protocols.

This specification uses the term “configured to” in connection with systems, apparatus, and computer program components. That a system of one or more computers is configured to perform particular operations or actions means that the system has installed on it software, firmware, hardware, or a combination of them that in operation cause the system to perform those operations or actions. That one or more computer programs is configured to perform particular operations or actions means that the one or more programs include instructions that, when executed by data processing apparatus, cause the apparatus to perform those operations or actions. That special-purpose logic circuitry is configured to perform particular operations or actions means that the circuitry has electronic logic that performs those operations or actions.

The subject matter described in this specification can be implemented in various implementations and may result in one or more of the following advantages. In some implementations, the systems and methods described in this specification can improve reliability of property monitoring systems. When a lead device of a security system fails, another device can automatically take over as the new lead device, improving reliability. In some implementations, the systems and methods described in this specification can reduce the amount of time to recover a failed prior lead device. The new lead device can obtain and process sensor data that was generated prior to failure of the prior lead device in order to determine a cause of the failure. The systems and methods described in this specification can enable operations of property monitoring systems without designated control panels.

Individual devices can perform functions that would otherwise be performed by a control panel. This can improve flexibility and portability of monitoring systems.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 depicts an example environment in for decentralized security monitoring.

FIGS. 2A to 2D illustrate example stages of replacing a lead device of a set of devices with a new lead device selected by a monitoring system.

FIG. 3 is a flow diagram of an example process for replacing a lead device of a set of devices with a new lead device selected by a monitoring system.

FIGS. 4A to 4D illustrate example stages of replacing a lead device of a set of devices with a new lead device selected by the set of devices.

FIG. 5 is a flow diagram of an example process for replacing a lead device of a set of devices with a new lead device selected by the set of devices.

FIG. 6 is a diagram illustrating an example of a property monitoring system.

Like reference numbers and designations in the various drawings indicate like elements.

### DETAILED DESCRIPTION

A monitoring system for a property includes multiple devices. At least some of the devices include a sensing component, a processing component, and a communication component. The sensing component can be, for example, a camera, motion detector, smoke detector, carbon monoxide sensors, glass break sensors, contact sensor, proximity detector, water sensor, or other type of sensor.

At least some of the devices are capable of executing a security application that can analyze sensor data from various types of sensors. At any given time, one device may be assigned as a lead device of the multiple devices. The lead device executes the security application to analyze sensor data generated by at least some of the other devices in order to detect events occurring at a property. The lead device can perform functions that typically would be performed by a security panel and can change over time. For instance, the lead device is communicable with a monitoring system, a central alarm system, or both, either of which can be a cloud system. The lead device can change security settings at the property, such as by arming and disarming a security state of devices at the property. The lead device can transmit instructions e.g., computer instructions as part of a message, that cause adjustments to devices at the property such as a door lock.

When a failure of the lead device occurs, e.g., a failure of the lead device to communicate with the monitoring system, another device takes over the role of the lead device for the property. In some examples, the monitoring system detects failure of the prior lead device and assigns the new lead device. In some examples, one of the devices at the property self-assigns as the new lead device or instructs another device to become the new lead device upon detecting failure of the prior lead device.

Detection of failure of the lead device can occur in various ways. In some cases, the multiple devices and/or the monitoring system perform periodic test communications with the lead device, and failure of the lead device is detected when the periodic test communication fails. In some cases, the lead device broadcasts a distress signal upon failure or immediately prior to failure. The distress signal can include, for example, a wireless communication signal, an audible signal, or a visual signal. One or more of the multiple devices and/or the monitoring system can detect the distress signal and determine that the prior lead device has failed. In some examples, the distress signal is encoded with information indicating a type of failure.

Selection of the new lead device can be based on attributes of the multiple devices. Attributes of the devices can include, for example, processing capacity, power level, connectivity status, bandwidth, or any combination of these. In some examples, the new lead device is assigned based on a pre-determined hierarchy of the multiple devices. The pre-determined hierarchy can be static or can be variable. For example, in some cases a monitoring system maintains a pre-determined hierarchy of the multiple devices based on attributes of the devices, and the hierarchy does not change over time. In some cases, the monitoring system maintains a pre-determined hierarchy of the multiple devices based on attributes of the devices, and the hierarchy changes over time based on factors such as changing network connectivity strength and changing power levels of the devices.

When a new lead device is assigned, the new lead device can perform an initialization process. The initialization process can include performing a discovery process to determine a status of each of, or a subset of, the multiple devices. In some examples, the initialization process includes sending a message to the multiple devices indicating that the prior lead device has been replaced with the new lead device. In some examples, the new lead device collects sensor data from the multiple devices that was generated prior to the failure of the prior lead device. The new lead device can determine a predicted cause of failure of the prior lead device. The new lead device can send information indicating the predicted cause of the failure to the monitoring system or perform another appropriate action.

In some cases, the functions of the lead device can be shared between two or more devices. For example, one device can perform data collection and analysis, and transmit results of the analysis to a second device that relays the information to the monitoring system. The functions can be shared due to operational limitations of various devices. For example, a first device may have strong connectivity to the monitoring system, but slower processing speeds. In this example, a second device having greater processing speeds can perform the data collection and analysis, while the first device performs the communications with the monitoring system.

In some cases, the function of the lead device can be transferred to the monitoring system. For example, there may be a delay in establishing a new lead device after failure of a prior lead device. The monitoring system can perform the functions of the lead device in the interim.

In this specification, a device can be configured for the property in any appropriate manner. For instance, the device can be physically installed at the property, such as a camera, a wireless router, or a television. The device can have an application installed on the device that enables the device to access sensor data captured at the property. In some examples, the device can receive alerts from a monitoring system that analyzes sensor data captured at the property.

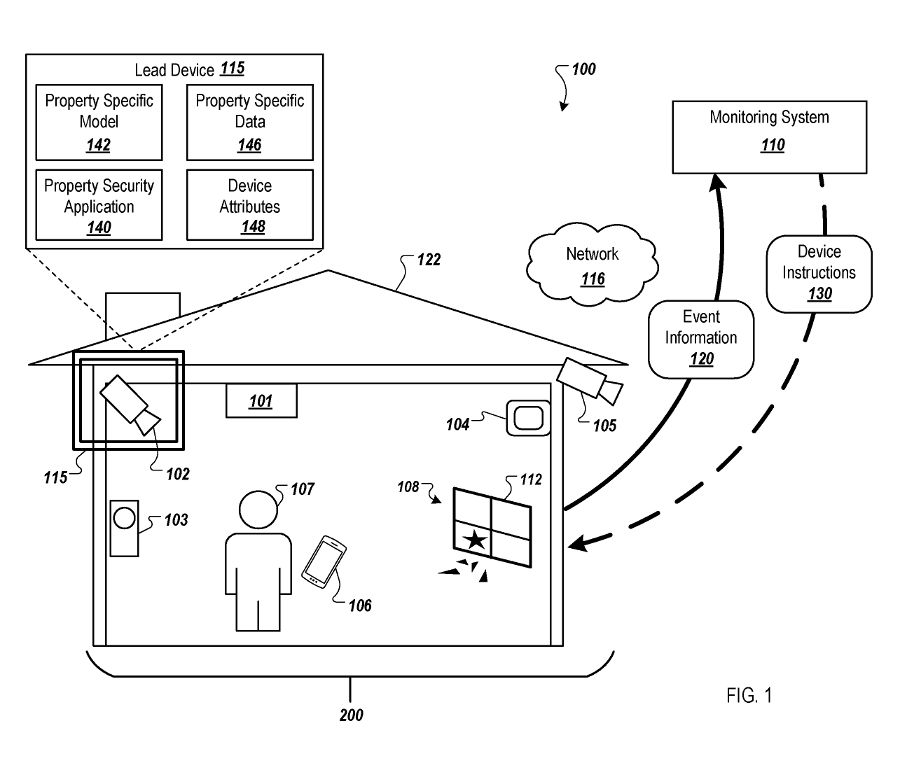

FIG. 1 depicts an example environment 100 for decentralized security monitoring. The environment 100 includes a property 122 with a set of devices 101-106 (“set of devices 200”) of a property monitoring system. The set of devices includes two or more devices. At least some of, and potentially all of, the devices of the set of devices 200 are capable of wireless communication with a monitoring system 110. Each device of the set of devices 200 is capable of wireless communication with at least some of the other devices of the set of devices 200. The wireless communication can be provided by a communication component. Wireless communication can include wireless radio frequency communication such as Bluetooth communication or Wi-Fi. Wireless communication can include audio and/or visual communication. For example, devices can emit audio signals such as ultrasonic signals, audible tones, and/or vocal sounds. Other devices (e.g., devices including a microphone) can detect the audio signals. In some examples, devices can emit visible signals such as flashing lights, projected images, and/or projected text. Other device (e.g., devices including an image sensor) can detect the visible signals.

The devices of the set of devices 200 can each be any appropriate type of device. For instance, the set of devices 200 include a smoke detector 101 and an indoor camera 102. In some examples, multiple sensors can be included in a single device, e.g., the smoke detector 101 can include an imaging sensor such as a camera. The devices at the property 122 can include a motion sensor 103, a glass break sensor 104, and an outdoor camera 105. In the example environment 100, the devices 101-105 are sensing devices. The devices 101-105 are installed at the property 122 and may each have a fixed position at the property 122. In some instances, at least one of the devices 101-105 can have an unfixed location, e.g., when the device is a robot for the property 122 that can move throughout the property 122.

In the example environment 100, a user 107 associated with the property 122 operates a mobile device 106. The mobile device 106 can be transported around the property 122, may be transported away from the property 122, and may reenter the property 122 after being transported away from the property 122. The mobile device 106 can include integrated sensors, e.g., sensing components, such as a microphone, camera, light sensor, temperature sensor, motion sensor, proximity sensor, touch sensor, accelerometer, GPS sensor, moisture sensor and/or other types of sensors.

Each device of the set of devices 200 can include a sensing component, a communication component, a processing component, and a memory component. At least some devices of the set of devices 200 can have a property specific model 142, property specific data 146, or both, stored in memory. Any device of the set of devices 200 can run a property security application 140. The property security application 140 can enable the device to communicate with other devices of the set of devices 200 and to communicate with the monitoring system 110. The property security application 140 can enable a device to analyze sensor data and identify events that are occurring at the property 122 based on analyzing the sensor data. Thus, any device of the set of devices 200 in the environment 100 can use captured sensor data to generate event information 120 representing events that occur at the property 122. Events can include, for example, security breaches, power outages, medical emergencies, fire and smoke events, flooding, and other types of events.

In some examples, at a given time, a particular device of the set of devices 200 is designated as a lead device 115 for the set of devices 200. The lead device 115 is represented in the figures with a double box around the device.

Referring to FIGS. 1 to 4, a solid double box represents a current lead device. A dashed double box represents a new lead device. Communication of information is represented by solid arrows. Communication of instructions is represented by dashed arrows. Diminished communications are shown as dotted arrows. Diminished communications are communications that do not satisfy one or more capability criteria. Capability criteria can include, for example, a specified threshold signal strength, a specified threshold bandwidth, a specified threshold communication speed, a specified threshold connectivity, a specified threshold consistency of power, a specified threshold consistency of connectivity, or any combination of these.

The lead device 115 receives sensor data generated by other devices of the set of devices 200. The lead device 115 can analyze the received data and can analyze the sensor data generated by the lead device 115 to generate the event information 120. The lead device 115 can perform local processing, e.g., using one or more processors included in the lead device 115, to determine whether one or more event criteria are satisfied. The lead device 115 can send the event information 120 to the monitoring system 110 in response to determining that the event criteria is satisfied.

For instance, the indoor camera 102 can receive sensor data that was captured by the glass break sensor 104 and can analyze the sensor data to determine whether an event 108, e.g., a window breakage, occurred. In some cases, the indoor camera 102 analyzes the sensor data from the glass break sensor 104 in combination with sensor data generated by the indoor camera 102 to determine whether the event 108 occurred. For example, the indoor camera 102 can generate image data showing a broken window 112 and the glass break sensor 104 can generate sensor data indicating detection of glass breaking.

In some examples, multiple devices that are capable of functioning as a lead device can receive the sensor data by the other devices of the set of devices 200. A device that is not designated as the lead device may store the received data and might take no further action with the received sensor data. A device that is designated as the lead device can process the received sensor data and perform appropriate actions using the sensor data. When a new lead device is assigned, the new lead device can access the previously received sensor data to determine current statuses of the devices.

In some examples, the lead device 115 can have the property specific model 142, the property specific data 146, or both, stored in memory. The lead device 115 can store one or both of the property specific model 142 or the property specific data 146 in an encrypted format, e.g., increasing data security. Receipt of the processing instruction can cause the lead device 115 to use one or both of the property specific model 142 or the property specific data 146 when processing the sensor data.

For instance, the property specific model 142 can be a machine learning model trained specifically for the property 122, e.g., given particular types of events, people, or both, for the property. The lead device 115 can update the property specific model 142 in response to detection of events at the property 122; using input from a person, e.g., indicating responses to notifications presented by the lead device 115; using data from other devices for the property 122; or a combination of these. For instance, as a person is detected leaving for work at the same time on particular days of the week, e.g., Tuesday through Saturday, the lead device 115 can update the property specific model 142 using that data. The property specific model 142 can be provided training data that represents a location at which the person parks their vehicle. As a result, the property specific model 142 is trained on data that is specific to the property 122 and that is potentially sensitive data.

The property specific data 146 can include data that is specific to the property 122, e.g., images of portions of the property; various types of personal information whether an image or schedule data or otherwise; a biometric model for detecting a specific person; other types of data for which there might be data privacy concerns; or a combination of these. A biometric model can be a model that represents an entity such as a person, a person’s face, a vehicle, or an animal, e.g., pet. The entity can have a threshold likelihood of being at the property, e.g., a frequent visitor, an employee, or a resident. In some examples, the property specific data 146 can represent activity that occurs at the property 122 at least a threshold amount of time, e.g., normal activity at the property 122. In some examples, the property specific data 146 can represent activity that does not occur at the property 122 at least the threshold amount of time, e.g., abnormal activity at the property 122.

By maintaining one or both of the property specific model 142 or the property specific data 146 on the lead device 115, the environment 100 can have increased data security, e.g., compared to environments in which some models or data is stored at a separate system, such as at the cloud.

By having one or both of the property specific model 142, or the property specific data 146, the lead device 115 can more easily make updates specific to the property 122, devices for the property 122, people at the property 122, or a combination of these, compared to other systems. For instance, the updates can be easier because the lead device 115 would have access to a larger amount of data necessary for the update with fewer network communications in contrast to other systems that store the model, data, or both, at a different location, e.g., on the cloud. Updates for devices for the property 122 can include updates to respective models for different cameras physically installed at the property 122 so that those cameras more accurately detect events at the property 122. For example, since the lead device 115, or a combination of devices for the property 122, maintain the property specific model 142, the property specific data 146, or both, these devices can more easily make updates to the corresponding features given a smaller amount of data required in contrast to a cloud-based system that would be required to manage a larger amount of data for multiple properties.

At least some of the other devices 200 can have a property security application 140 installed on the device. The lead device 115 can use the property security application 140, e.g., a home security application, to process the sensor data. For instance, the property security application 140 can use the property specific model 142 to process the sensor data, e.g., and optionally at least a portion of the property specific data 146. In these examples, the property security application 140 can maintain the property specific model 142, the property specific data 146, or both, in memory.

In some examples, the property security application 140 can execute a server process that receives the sensor data and the processing instruction. The received sensor data and processing instruction can be encrypted, e.g., by the lead device 115 or another device that sends the processing instruction to the lead device 115. The lead device 115 receives a message via a secure local channel. The message can include any appropriate type of, e.g., encrypted, data, such as the sensor data; the processing instruction; any existing processing results, e.g., fast-low quality object detection; metadata; or a combination of two or more of these. The metadata can include a timestamp, a camera identifier, calibration data, data indicating a requested task for processing the sensor data, or a combination of two or more of these. Although the lead device 115 can receive data indicating a requested task, the lead device 115 can perform any appropriate operations such as discarding the sensor data without performing the requested task, or performing additional non-requested processing, e.g., as determined by the property security application’s 140 internal logic.

A device of the set of devices, when functioning as the lead device 115, can perform any one or more of the following functions: arming the property monitoring system, disarming the property monitoring system, changing an alert mode of the property monitoring system, changing a stay/away state of the property monitoring system, detect and register new sensors or other devices when they are added to the monitoring system, monitoring the status of all sensors and other devices and respond accordingly when a sensor is activated, providing an option for users to arm and disarm the property monitoring system, receiving a user instruction to arm and disarm the monitoring system, providing an exit delay after the system is armed, allowing occupants to leave the property without triggering an alarm, providing an audible or visual confirmation when the system is armed or disarmed, providing an entry delay after a sensor is activated, allowing occupants to enter the property and disarm the system without triggering an alarm, providing options for users to adjust alarm settings such as duration and volume, triggering alarms, clearing alarms, sending an alert to a remote system when an alarm is triggered, sending status updates to the remote system when the system is armed or disarmed, sending alerts to user devices, sending status updates to user devices, encrypting communications, authentication communications, performing regular self-checks of system communication capabilities, triggering an alert when tampering is detected, receiving commands from the monitoring system 110, or interact with smart devices such as turning on and off lights. Here, the property monitoring system can be represented by the devices at the property 122. The status, e.g., armed or disarmed, or mode of the property monitoring system can affect the operations performed by the devices in the property monitoring system.

Upon detection of the event 108, the lead device 115 can trigger capture of sensor data by other sensors at the property 122, retrieval of previously captured sensor data, analysis of captured sensor data, or a combination of these. In some instances, the detection of the event 108 might not immediately trigger presentation of an alert, e.g., at the property 122 or otherwise for the property 122. For instance, the lead device 115 can analyze the captured sensor data, send the event information 120 to the monitoring system 110, or both, before triggering an alert.

The event information 120 can include information about any of the following types of events: arming of the monitoring system, disarming of the monitoring system, monitoring system entering away mode, monitoring system entering stay mode, activation of a device of the set of devices 200, low battery of a device of the set of devices 200, loss of communication with a device of the set of devices 200, or detection of tampering with devices of the set of devices 200.

The lead device 115 can instruct one or more other devices of the set of devices 200 at the property 122 to capture second sensor data, e.g., that will be or was captured after detection of the event 108. The other sensors can be all devices of the set of devices 200 or a proper subset of set of devices 200 at the property 122. For example, the lead device 115 can identify the devices that are within a threshold distance of the event 108 and trigger those identified devices to capture the second sensor data. The threshold distance can be determined by a unit of measurement, e.g., feet or meters, a number of rooms, or some other appropriate distance. In the example shown in FIG. 1, upon detecting the window breakage, the lead device 115 can trigger the motion sensor 103 to capture motion sensor data indicating motion near the broken window 112. In some implementations, at least some devices of the set of devices 200 can capture sensor data continuously, e.g., without receiving a trigger to capture sensor data. In these implementations, the lead device can continually receive second sensor data from these devices and store the received sensor data in memory.

In some examples, the lead device 115 can access sensor data that was previously captured. The sensor data can be maintained in a database. The database can be at any appropriate location, e.g., at the property 122, in the monitoring system 110, implemented in the lead device 115, or on another device or combination of devices. The previously captured sensor data is sensor data that was captured before the event 108 was detected, e.g., even though the sensor data might have been captured after the event 108 occurred. For example, the previously captured sensor data can include one or more images of the window that were captured by the indoor camera before detection of the event 108.

The lead device 115 can determine previously captured sensor data to access. For instance, the lead device 115 can use a time period threshold to access previously captured sensor data that was captured at a time that satisfies the time period threshold. This can include accessing previously captured sensor data that was captured, e.g., five minutes before the event 108 was detected. When analysis of the previously captured sensor data, e.g., by the monitoring system 110, indicates that the event 108 likely began more than the time period threshold before the event 108 was detected, the lead device 115, the monitoring system 110, or both, can access additional previously captured sensor data.

The monitoring system 110 receives the event information 120 from the lead device 115. The event information 120 can include the collected sensor data, data that identifies the detected event, or other appropriate data for the detected event 108.

The monitoring system 110 can analyze the event information 120 and determine whether to perform actions. Actions can include generating alerts for the event. Actions can include sending device instructions 130 to the set of devices 200. For instance, the monitoring system 110 can send device instructions 130 that cause one or more devices of the set of devices 200 to capture additional sensor data and/or send additional sensor data to the lead device 115. In some examples, the device instructions 130 cause a change in an alarm status at the property 122. For example, the device instructions 130 can activate an audible and/or visual alarm at the property 122.

In some implementations, the device instructions 130 can cause one or more monitoring system components at the property 122 to perform automated action. In the example of a detected fire or smoke event, automated actions can include causing a component at the property 122 to output water, turn off electricity, provide access to an entrance for emergency services, or a combination of these. Provision of access to an entrance can include unlocking a door, opening a door, maintaining a door in an open position, another appropriate action, or a combination of these. In the example of a detected flooding event, automated actions can include shutting a valve at the property 122, opening a drain, shutting a door, maintaining a door in a shut position, another appropriate action, or a combination of these. Automated actions can include adjusting a temperature at the property, sounding an alarm, or presenting an alert, e.g., a visual or audible alert.

In some examples, the monitoring system 110 can determine to skip presenting an alert for an event based on the event information 120. This can result in saved computational resources, e.g., given the lack of transmission of data to a presentation device for an alert; reduced property risk; reduced human resources, e.g., when monitoring or emergency services personnel don’t have to respond to the event; or a combination of these.

The monitoring system 110 is an example of a system implemented as computer programs on one or more computers in one or more locations, in which the systems, components, and techniques described in this specification are implemented. A network 116, such as a local area network (“LAN”), wide area network (“WAN”), the Internet, or a combination thereof, connects the set of devices 200, and the monitoring system 110. In some examples, the monitoring system 110 can be part of, e.g., implemented on, a monitoring system included at the property 122, e.g., and that includes the set of devices 200. In some instances, the monitoring system 110 can be implemented on a sensor, e.g., a camera. In these instances, the cloud system can be implemented as a local system instead of a cloud system. The monitoring system 110 can use a single computer or multiple computers operating in conjunction with one another, including, for example, a set of remote computers deployed as a cloud computing service.

The various functional components of the monitoring system 110 can be installed on one or more computers as separate functional components or as different modules of a same functional component. For example, the components of the monitoring system 110 can be implemented as computer programs installed on one or more computers in one or more locations that are coupled to each through a network. In cloud-based systems for example, these components can be implemented by individual computing nodes of a distributed computing system.

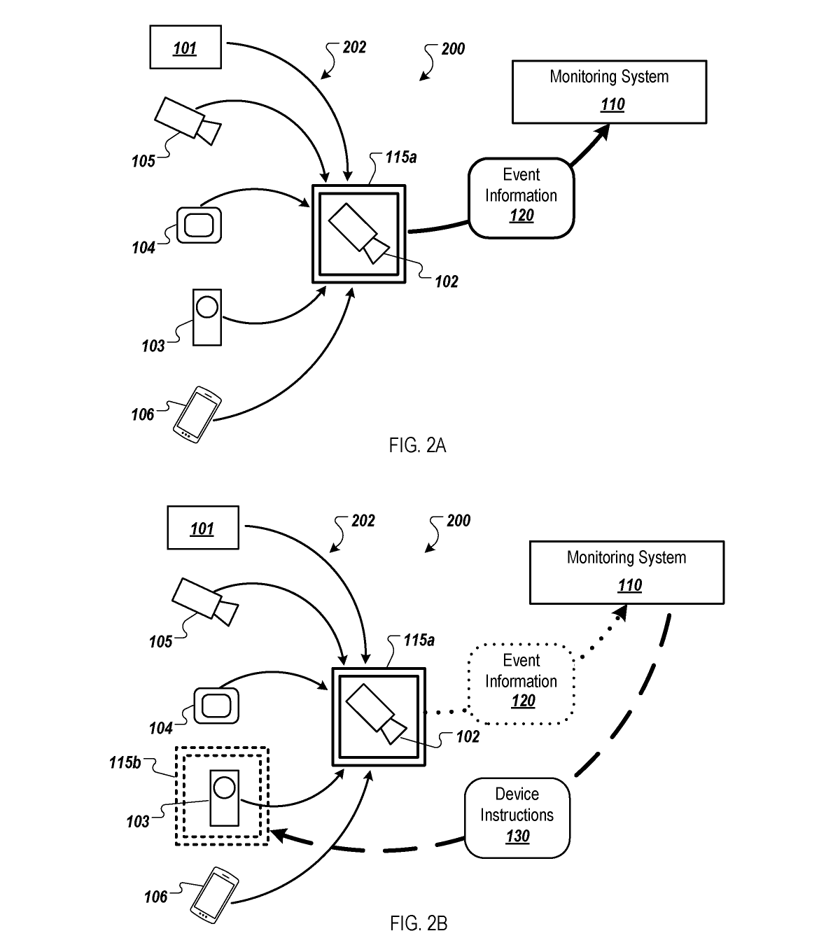

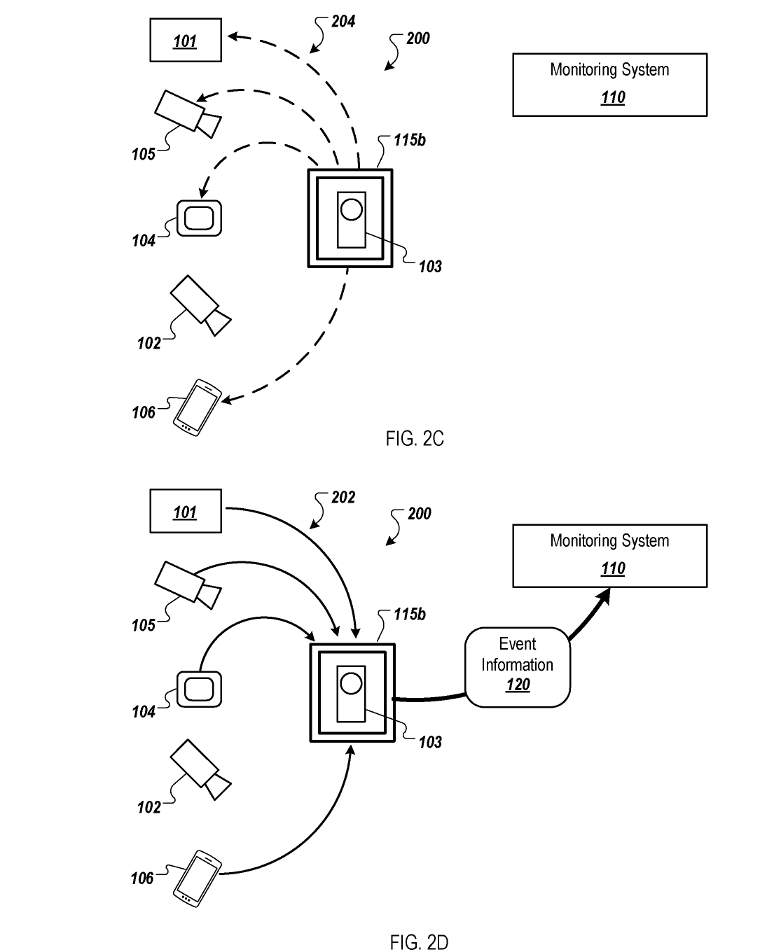

Failure of the lead device 115 can occur. Failure can include, for example, a loss of power of the lead device 115 or a loss or reduction in communication capabilities of the lead device 115. Failure of the lead device 115 is described in greater detail with reference to FIGS. 2 through 4.

When the lead device 115 experiences a failure, a new lead device can be selected from the set of devices 200. The new lead device can be selected by the prior lead device 115, by the monitoring system 110, or another device in the set of devices 200, e.g., the new lead device can be self-selected by the new lead device. The selection of the new lead device can use any appropriate data, process, or combination of both. For instance, the monitoring system 110 can use attribute data that indicates attributes of the one or more other devices 200, attributes about the sensor data, attributes about the network 116, other appropriate data, or a combination of two or more of these, when selecting the new lead device for processing the sensor data and communicating with the monitoring system 110.

For example, the monitoring system 110 can select a device that is hardwired to a power source; has the highest computational resources (e.g., a smart phone with a faster processor, more memory, or both); or a combination of these. Some examples of computational resources include access to additional hardware resources, additional compute resources, additional battery life, additional artificial intelligence, e.g., neural, processing resources, or a combination of these. In some examples, when a smart phone might have the highest computational resources of the other devices 200 but has a battery life that does not satisfy a battery threshold, the monitoring system 110 can select a device with a hardwired power connection (e.g., a wireless router or a television) as the new lead device.

In some implementations, one or more of the set of devices 200 can periodically transmit a processing capability advertisement signal. The processing capability advertisement signal can indicate one or more device attribute information 148. The device attribute information 148 can be any appropriate type of data, e.g., as described elsewhere in this specification as relates to data about one of the other devices 200. The monitoring system 110, or a device in the set of devices 200, can use data from the processing capability advertisement signal when selecting a device as a new lead device.

Receipt of the processing instruction by the new lead device 115 causes the new lead device 115 to process the sensor data, e.g., captured by other devices in the set of devices 200 which sensor data would not otherwise be processed. For instance, the processing instruction can be a general instruction that indicates that the sensor data should be processed or a specific instruction that indicates one or more operations to perform using at least some of the sensor data. The new lead device 115 can then perform one or more operations as part of the processing of the sensor data.

Devices of the set of devices 200 can include personal computers, mobile communication devices, televisions, wireless routers, security panels, and other devices that can send and receive data over the network 116, e.g., a Wi-Fi, Z-wave, or Bluetooth network. The local area network connects the lead device 115 and the other devices of the set of devices 200. Sometimes the local area network can connect to another network (not shown), wide area network (“WAN”), the Internet, or a combination thereof, for instance when transmitting data to or receiving data from a smartphone for the property 122, a cloud-based system, or a combination of both. In some implementations, at least some of the set of devices 200 can communication over a wide area network such as the Internet or a cloud-computing connection.

The set of devices 200 can each include several different functional components, including the property specific model 142 and the property security application 140. The property specific model 142, the property security application 140, or a combination of these, can include one or more data processing apparatuses, can be implemented in code, or a combination of both. For instance, each of the property specific model 142 and the property security application 140 can include one or more data processors and instructions that cause the one or more data processors to perform the operations discussed herein. Memory that stores the instructions, e.g., code, can implement a memory component. A processing component can be implemented in one or more processors, e.g., the one or more data processors, software that executes on one or more processors, or a combination of both.

In some implementations, the property specific model 142, the property specific data 146, or a combination of both, can be transmitted between various devices for the property, e.g., the set of devices 200. This can occur when a device updates the property specific model 142, the property specific data 146, or both or when a new device is selected as lead device. For instance, when a television is selected as the lead device, another of the other devices 200 can transmit the property specific model 142 to the television to enable the television to process the sensor data.

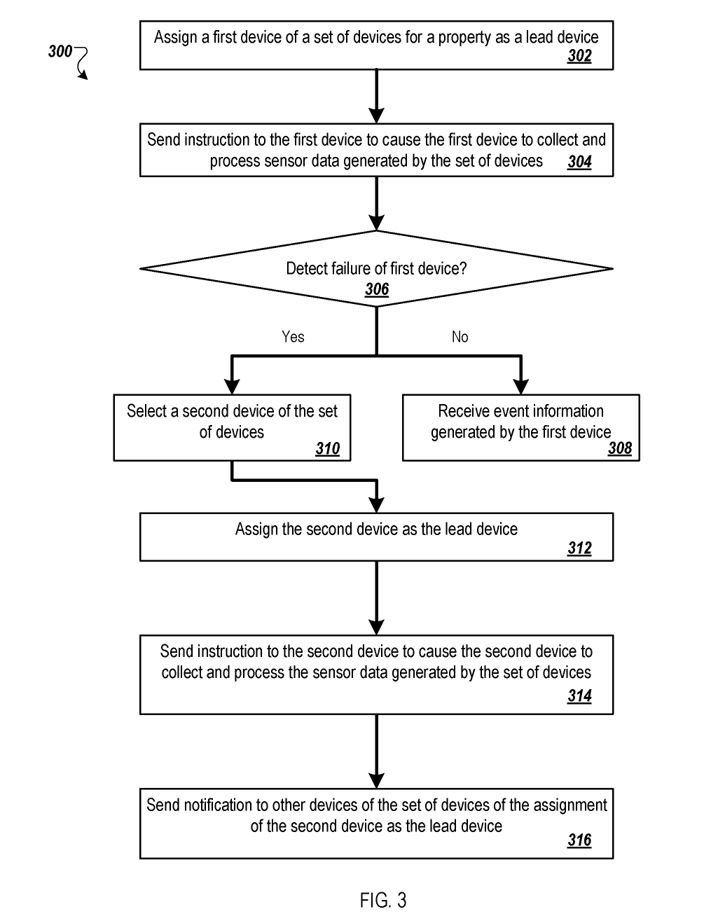

FIGS. 2A to 2D illustrate example stages of replacing a lead device of a set of devices 200 with a new lead device selected by a monitoring system. The set of devices 200 includes the smoke detector 101, the outdoor camera 105, the glass break sensor 104, the motion sensor 103, the mobile device 106, and the indoor camera 102. Generally, referring to FIGS. 2A to 2D, communication of information is represented by solid arrows. Communication of instructions is represented by dashed arrows. Diminished communications are shown as dotted arrows. Steps of a process for replacing the lead device with a new lead device will be described with reference to FIG. 3.

FIG. 3 is a flow diagram of an example process 300 for replacing a lead device of a set of devices with a new lead device selected by a monitoring system. The process 300 can be performed by a computing system including one or more computers. For example, the process 300 can be used by the monitoring system 110 from the environment 100.

The process 300 includes assigning a first device of a set of devices for a property as a lead device (302). For example, referring to FIG. 2A, the indoor camera 102 is assigned as the lead device 115a of the set of devices 200. Once assigned as lead device, the first device is maintained as lead device. This can include maintaining data in memory that indicates that the first device is the lead device.

The process 300 includes sending an instruction to the first device to cause the first device to collect and process sensor data generated by the set of devices (304). For example, the monitoring system 110 can send an instruction to the indoor camera 102 to cause the indoor camera 102 to collect and process sensor data 202 generated by the set of devices 200. The indoor camera 102 generates event information 120 from the sensor data 202 and sends the event information 120 to the monitoring system 110. In some instances, sending the instruction can be part of assigning the first device as the lead device.

The process 300 includes determining whether a failure of the first device is detected (306). The process can determine whether the failure of the first device is detected according to a schedule, randomly, based on receipt of data, based on non-receipt of data, or any combination of these.

If failure of the first device is not detected, the system continues to receive event information generated by the first device (308). For example, referring to FIG. 2A, the indoor camera 102 receives the sensor data 202 from the set of devices 200 and the indoor camera 102 generates event information 120 using the sensor data 202. The indoor camera 102 continues to send the event information 120 to the monitoring system 110 and the monitoring system 110 receives the event information.

In response to detecting the failure of the first device, the system selects a second device of the set of devices (310). For example, referring to FIG. 2B, the monitoring system 110 detects failure of the indoor camera 102. Failure of the indoor camera 102 can include, for example, loss of power to the indoor camera 102, loss of connectivity between the indoor camera 102 and the monitoring system 110, or both.

In some examples, failure of the indoor camera 102 includes diminished communication capabilities between the indoor camera 102 and the monitoring system 110. In some examples, failure of the indoor camera 102 can include diminished communication capabilities between the indoor camera 102 and other devices of the set of devices 200. Diminished communication capabilities can include the indoor camera 102 being unable to directly communicate with the monitoring system. Diminished communication capabilities can include the indoor camera 102 having a reduced bandwidth available for communication. A reduced bandwidth can be a bandwidth that does not satisfy (e.g., is less than) a threshold bandwidth. A reduced bandwidth can be a bandwidth for which a difference between the bandwidth and a baseline bandwidth satisfies (e.g., exceeds) a threshold difference. A reduced bandwidth can be a bandwidth that is at least a threshold amount different from (e.g., less than) a baseline bandwidth.

In some examples, the monitoring system 110 detects diminished communication capabilities based on a lack of receipt of communication from the indoor camera 102. For example, when assigned as the lead device 115a, the indoor camera 102 can send a periodic signal to the monitoring system 110 indicating that the indoor camera 102 has power and is functioning properly. The indoor camera 102 may fail to send the periodic signal due to incidents such as the indoor camera 102 losing connection with the network 116 or due to the indoor camera 102 losing power. The monitoring system 110 can detect the diminished communication capabilities of the indoor camera 102, and therefore the failure of the indoor camera 102, based on not receiving the periodic signal from the camera 102 for at least a threshold duration of time.

In some examples, the monitoring system 110 detects diminished communication capabilities based on a failure of a test communication with the indoor camera 102. For example, when the indoor camera 102 is assigned as the lead device 115a, the monitoring system 110 can send a periodic or occasional test communication, e.g., a ping, to the indoor camera 102. The test communication can instruct the indoor camera 102 to perform a specified action such as sending a response message to the monitoring system 110. The indoor camera 102 may fail to perform the specified action due to incidents such as the indoor camera 102 losing connection with the network 116 or due to the indoor camera 102 losing power. The monitoring system 110 can detect the diminished communication capabilities of the indoor camera 102, and therefore the failure of the indoor camera 102, based on determining that the indoor camera 102 did not perform the specified action (e.g., the monitoring system 110 did not receive the response message from the indoor camera 102 after sending the test message to the indoor camera 102).

In some examples, the monitoring system 110 detects failure of the first device based on receiving a communication from another device of the set of devices 200. For example, the indoor camera 102 can experience a failure such as a loss or reduction of network connectivity, and can notify at least one other device of the set of devices 200 of the failure. The indoor camera 102 can notify the at least one other device (e.g., the outdoor camera 105) of the failure, for example, by sending a wireless message to the other device, by emitting an audible distress signal, by emitting a visible distress signal, or any combination of these. In some examples, the distress signal is encoded with a pattern indicating a type of distress. For example, the indoor camera 102 can emit a distress signal by flashing lights with a specified color and/or pattern that indicates reduction in connectivity. In some examples, the indoor camera 102 emits a distress signal by broadcasting audible tones at a specified frequency and/or pattern that indicates loss of power. The outdoor camera 105 can detect the distress signal emitted by the indoor camera 102 and can send a message to the monitoring system 110 to inform the monitoring system 110 of the failure of the indoor camera 102. In some instances, the outdoor camera 105 can be a device at another property, e.g., within a threshold distance of the property 122.

In some examples, the monitoring system 110 detects failure of the first device based on detecting a distress signal from the first device. For example, the indoor camera 102 can detect a predicted impending failure such as a loss or reduction of network connectivity, and can notify the monitoring system 110 of the predicted impending failure. The indoor camera 102 can notify the monitoring system 110 of the failure, for example, by sending a wireless message to the monitoring system 110 to inform the monitoring system 110 of the impending failure of the indoor camera 102.

The monitoring system 110 can select the new lead device 115b using one or more criteria. The monitoring system 110 can evaluate device attribute information 148 of the devices of the set of devices 200 to identify devices that satisfy the criteria. The criteria can include, for example, a threshold power level of the device, a threshold connectivity level of the device, a threshold bandwidth of the device, a threshold amount of available memory of the device, and/or other criteria. In the example of FIG. 2B, the monitoring system 110 selects the motion sensor 103 as the new lead device 115b.

In some examples, the monitoring system 110 selects the motion sensor 103 as the new lead device 115b using a predetermined hierarchy of devices, device types, or both. The pre-determined hierarchy can be fixed or can be variable. For example, in some cases the monitoring system 110 maintains a pre-determined hierarchy of the multiple devices based on attributes of the devices, and the hierarchy does not change over time. In some cases, the monitoring system 110 maintains a pre-determined hierarchy of the multiple devices based on attributes of the devices, and the hierarchy changes over time based on factors such as changing network connectivity strength, changing power levels of the devices, or both. When failure of the lead device 115a is detected, the monitoring system 110 can then select the device at the top of the pre-determined hierarchy as the new lead device 115b. If the new lead device 115b fails to assume the role of lead device, the monitoring system 110 can select the next device according to the pre-determined hierarchy. For example, the monitoring system 110 may send an instruction to the smoke detector 101 to assign the smoke detector 101 as the new lead device 115b. In response to the smoke detector 101 failing to acknowledge the assignment, the monitoring system 110 can select a different device according to the pre-determined hierarchy.

In some examples, the monitoring system 110 selects the motion sensor 103 as the new lead device 115b based on the motion sensor 103 having a higher connectivity level than other devices of the set of devices 200. In some examples, the monitoring system 110 selects the motion sensor 103 as the new lead device 115b based on the motion sensor 103 having a higher power level and/or more consistent power than other devices of the set of devices 200. In some examples, the monitoring system 110 selects the motion sensor 103 as the new lead device 115b based on the motion sensor 103 having greater bandwidth than other devices of the set of devices 200. In some cases, the monitoring system 110 computes and/or maintains a score for each device of the set of devices 200 based on attributes of the devices. The score can represent a power level of the device, a power source of the device, a connectivity level of the device, a bandwidth of the device, a consistency of connectivity of the device, a consistency of power of the device, or any combination of these. The monitoring system 110 can compute the score prior to failure of the lead device 115a, during failure of the lead device 115a, or after failure of the lead device 115b. The monitoring system 110 can assign, as the new lead device 115b, the device of the set of devices 200 with the highest score. If the device with the highest score fails to assume the role of the new lead device 115b, the monitoring system 110 can assign, as the new lead device 115b, the device with the next highest score.

The process 300 includes assigning the second device as the lead device (312). For example, referring to FIG. 2B, the monitoring system 110 assigns the selected device (e.g., motion sensor 103) as the new lead device 115b. After assigning the second device as the lead device, the monitoring system 110 can maintain the second device as the lead device.

The process 300 includes sending an instruction to the second device to cause the second device to collect and process the sensor data generated by the set of devices (314). For example, referring to FIG. 2B, the monitoring system 110 sends device instructions 130 to the motion sensor 103 that cause the motion sensor 103 to collect and process the sensor data 202.

The process 300 includes sending a notification to other devices of the set of devices of the assignment of the second device as the lead device (316). For example, referring to FIG. 2C, notifications 204 are sent to the other devices of the set of devices 200. The notifications 204 can be sent by the new lead device 115b (e.g., the motion sensor 103) or by the monitoring system 110. The notifications 204 indicate that the motion sensor 103 is assigned as the new lead device 115b.

Referring to FIG. 2D, after the other devices of the set of devices 200 are notified of the assignment of the motion sensor 103 as the lead device 115b, the other devices can send the sensor data 202 to the new lead device 115b. The new lead device 115b can then generate event information 120 using the sensor data 202 and send the event information 120 to the monitoring system 110.

In some examples, when a lead device 115a fails, the monitoring system 110 can begin to perform functions that were performed by the lead device 115a. For example, the monitoring system 110 can establish direct communications with multiple devices of the set of devices 200. The monitoring system 110 can collect sensor data from the multiple devices, and can generate event data using the collected sensor data.

The monitoring system 110 can determine to perform the functions that were performed by the lead device 115a when certain conditions are met. The conditions can include, for example, no devices of the set of devices 200 satisfying criteria for becoming the new lead device 115b.

The conditions for the monitoring server 110 to function as the lead device can include, for example, a detected level of instability of communications between the set of devices 200. For example, the monitoring system 110 may determine that the number of changes in assignment of lead devices exceeds a threshold number of changes within a predetermined period of time (e.g., the lead device assignment has changed three times within an hour, the lead device assignment has changed six times within twelve hours, etc. When the number of lead devices changes satisfies the threshold, the monitoring server 110 can determine to perform the function of the lead device until the communications stabilize.

The conditions for the monitoring server 110 to function as the lead device can include an emergency condition at the property 122. For example, the monitoring system 110 can determine, based on event information 120, that an emergency condition exists at the property 122 such as a radio frequency jamming event, a break-in, a fire, or another type of emergency condition. In response to determining that the emergency condition exists and in response to determining that the lead device 115 is failing or has failed, the monitoring system 110 can determine to perform the functions that were performed by the lead device 115a.

In some examples, when a lead device 115a fails, a device that is not included in the set of devices 200 can begin to perform functions that were performed by the lead device 115a. For example, a neighboring property can include one or more devices that are capable of communication with the set of devices 200. A device (e.g., an outdoor camera) at the neighboring property can detect a distress signal emitted by the lead device 115a. The device at the neighboring property can self-select as a new lead device or can receive an instruction to become the new lead device 115b. The device at the neighboring property can establish direct communications with multiple devices of the set of devices 200. The device at the neighboring property can collect sensor data from the multiple devices, and can generate event information 120 using the collected sensor data.

The device at the neighboring property can be selected to perform the functions that were performed by the lead device 115a when certain conditions are met. The conditions can include, for example, no devices of the set of devices 200 satisfying criteria for becoming the new lead device 115b. The conditions can include an emergency condition at the property 122. For example, the monitoring system 110 can determine, based on event information 120, that an emergency condition exists at the property 122 such as a radio frequency jamming event, a break-in, a fire, or another type of emergency condition. In response to determining that the emergency condition exists and in response to determining that the lead device 115a is failing or has failed, the monitoring system 110 can assign the device at the neighboring property to perform the functions that were performed by the lead device 115a. The conditions can include a loss of communication, or predicted loss of communication, between the set of devices 200 and the monitoring system 110. For example, all devices of the set of devices 200 may lose connectivity with the monitoring system 110. One or more of the devices can emit a distress signal that is detected by the device at the neighboring property. The distress signal can be encoded with information indicating the loss of connectivity with the monitoring system 110. In response to detecting the distress signal, the device at the neighboring property can begin to perform the functions of the lead device 115a and can communicate with the monitoring system 110 on behalf of the set of devices 200. The device at the neighboring property can collect sensor data from the set of devices 200, generate event information 120, and send the event information 120 to the monitoring system 110.

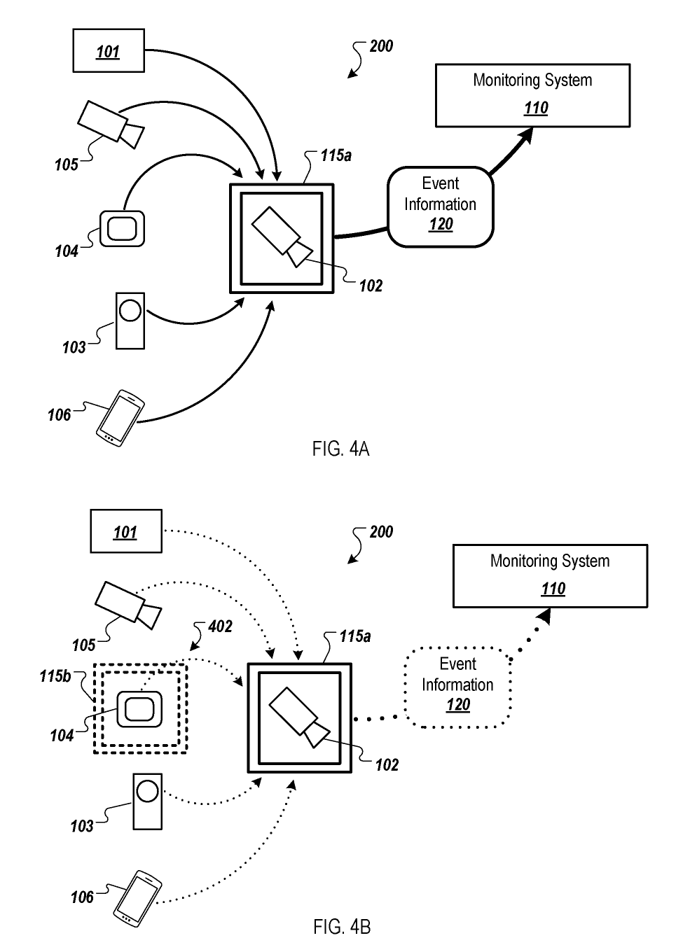

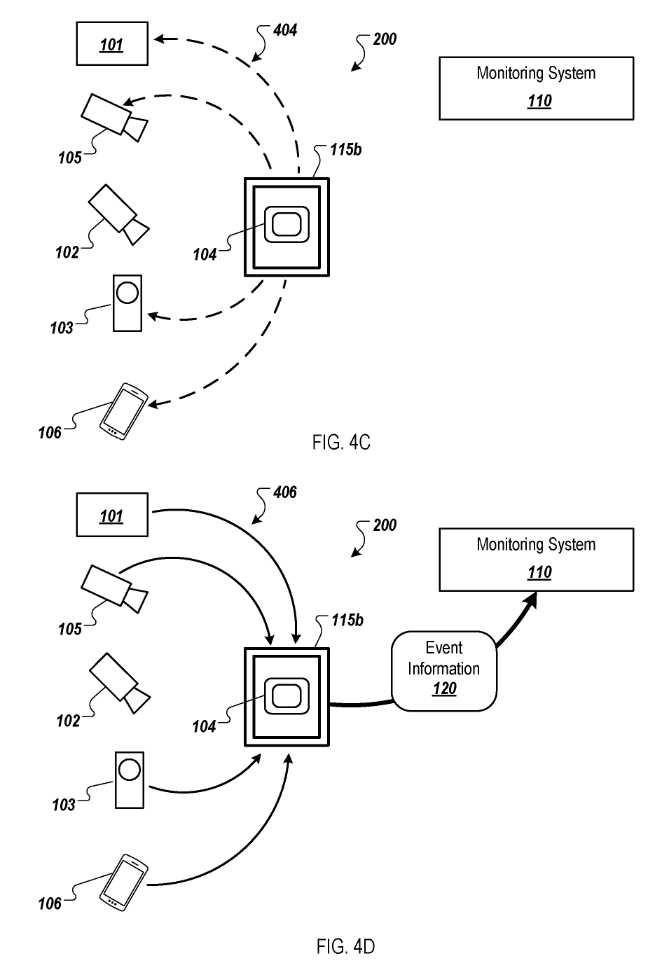

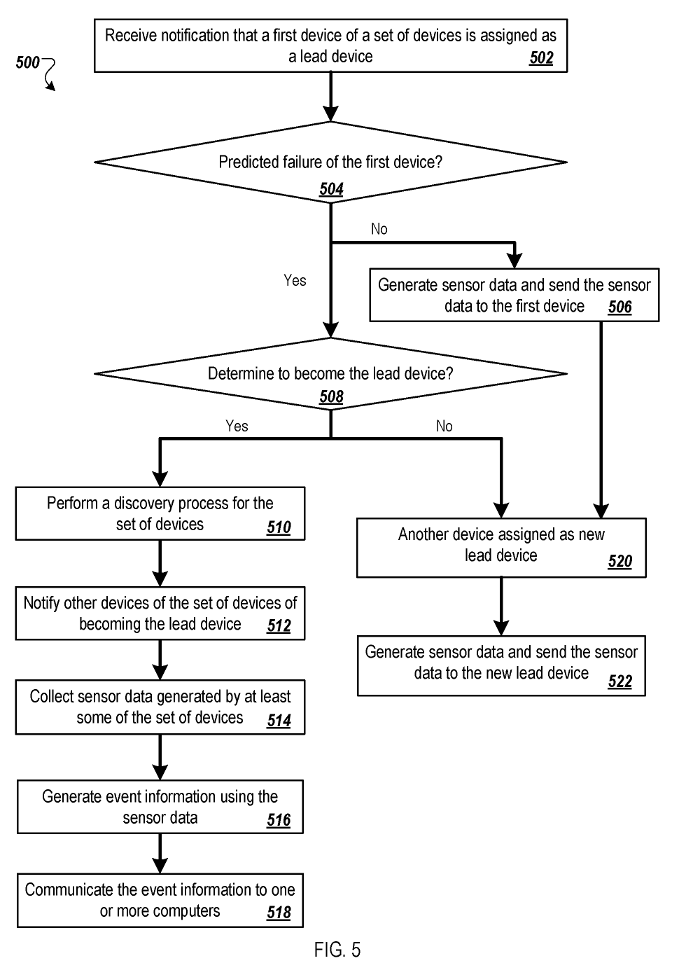

FIGS. 4A to 4D illustrate example stages of replacing a lead device of a set of devices with a new lead device selected by the set of devices 200. Generally, referring to FIGS. 4A to 4D, communication of information is represented by solid arrows. Communication of instructions is represented by dashed arrows. Diminished communications are shown as dotted arrows. Steps of a process for replacing the lead device with a new lead device will be described with reference to FIG. 5.

FIG. 5 is a flow diagram of an example process 500 for replacing a lead device of a set of devices with the new lead device selected by the set of devices. For example, the process 500 can be used by any device of the set of devices 200 from the environment 100.

The process 500 includes receiving a notification that a first device of a set of devices is assigned as a lead device (502). The first device can be assigned or otherwise maintained as the lead device, e.g., when such maintenance includes an identification in memory of the lead device. Multiple devices from the set of devices can maintain the identifier for the first device as the lead device, e.g., indicating the device to which the devices should transmit sensor data. For example, referring to FIG. 4A, the glass break sensor 104 can receive a notification that the indoor camera 102 is assigned as the lead device 115a. The glass break sensor 104 can receive the notification from the indoor camera 102, from the monitoring system 110, or from another device of the set of devices 200. With the indoor camera 102 assigned as the lead device 115a, the other devices of the set of devices 200 communicate with the indoor camera 102, e.g., using the data in memory of the respective other devices that identifies the lead device. In some examples, the devices engage in two-way communication with the indoor camera 102. For instance, the devices can send sensor data to the indoor camera 102. Each device can send device attribute information 148 to the indoor camera 102, such as a present power level and/or connectivity status of the device.

The devices can receive, from the indoor camera 102, instructions such as instructions that specify types of information to send the indoor camera 102. The instructions can specify a timing of sending information to the indoor camera 102. For example, the indoor camera 102 can poll each device for information according to a polling schedule. In some cases, the indoor camera 102 sends an acknowledgement message to a device in response to receiving information from the device. In some cases, the devices can exchange periodic or occasional test messages with the indoor camera 102 to verify connectivity between the devices and the indoor camera 102.

The process 500 includes determining whether failure of the first device is predicted (504). For example, referring to FIG. 4B, the glass break sensor 104 determines whether failure of the indoor camera 102 is predicted. Failure of the indoor camera 102 can include, for example, loss of power to the indoor camera 102, loss of connectivity between the indoor camera 102 and the glass break sensor 104, or both.

In response to determining that failure of the first device is not predicted, the process 500 includes generating sensor data and sending the sensor data to the first device (506). For example, referring to FIG. 4A, the glass break sensor 104 sends sensor data 402 to the indoor camera 102.

In response to predicting failure of the first device, the process 500 includes determining whether to become the lead device, assign another device as lead device, or both (508). In some examples, failure of the indoor camera 102 includes diminished communication capabilities between the indoor camera 102 and devices of the set of devices 200. In some examples, devices such as the glass break sensor 104 can detect diminished communication capabilities based on a lack of receipt of communication from the indoor camera 102. For example, when assigned as the lead device 115a, the indoor camera 102 can send a periodic signal to the glass break sensor 104 indicating that the indoor camera 102 has power and is functioning properly. The indoor camera 102 may fail to send the periodic signal due to incidents such as the indoor camera 102 losing connection with the network 116 or due to the indoor camera 102 losing power. The glass break sensor 104 can detect the diminished communication capabilities of the indoor camera 102, and therefore the failure of the indoor camera 102, based on not receiving the periodic signal from the camera 102 for at least a threshold duration of time.

In some examples, the glass break sensor 104 detects diminished communication capabilities based on a failure of a test communication with the indoor camera 102. For example, when the indoor camera 102 is assigned as the lead device 115a, the glass break sensor 104 can send a periodic or occasional test communication to the indoor camera 102. The test communication can instruct the indoor camera 102 to perform a specified action such as sending a response message to the glass break sensor 104. The indoor camera 102 may fail to perform the specified action due to incidents such as the indoor camera 102 losing connection with the network 116 or due to the indoor camera 102 losing power. The glass break sensor 104 can detect the diminished communication capabilities of the indoor camera 102, and therefore the failure of the indoor camera 102, based on determining that the indoor camera 102 did not perform the specified action (e.g., the glass break sensor 104 did not receive the response message from the indoor camera 102 after sending the test message to the indoor camera 102).

In some examples, the glass break sensor 104 detects failure of the first device based on receiving a communication from another device of the set of devices 200. For example, the indoor camera 102 can experience a failure such as a loss or reduction of network connectivity, and can notify at least one other device of the set of devices 200 of the failure. The indoor camera 102 can notify the at least one other device (e.g., the outdoor camera 105) of the failure, for example, by sending a wireless message to the other device, by emitting an audible distress signal, by emitting a visible distress signal, or any combination of these. In some examples, the distress signal is encoded with a pattern indicating a type of distress. For example, the indoor camera 102 can emit a distress signal by flashing lights with a specified color and/or pattern that indicates reduction in connectivity. In some examples, the indoor camera 102 emits a distress signal by broadcasting audible tones at a specified frequency and/or pattern that indicates loss of power. The outdoor camera 105 can detect the distress signal emitted by the indoor camera 102 and can send a message to the glass break sensor 104 to inform the glass break sensor 104 of the failure of the indoor camera 102.

In some examples, the glass break sensor 104 detects failure of the first device based on detecting a distress signal from the first device. For example, the indoor camera 102 can detect an impending failure such as a loss or reduction of network connectivity, and can notify the glass break sensor 104 of the impending failure. The indoor camera 102 can notify the glass break sensor 104 of the failure, for example, by sending a wireless message to the glass break sensor 104 to inform the glass break sensor 104 of the impending failure of the indoor camera 102.

In response to predicting failure of the indoor camera 102, the glass break sensor 104 can communicate the predicted failure to the monitoring system 110, to other devices of the set of devices 200, or both.

In response to predicting failure of the indoor camera 102, the glass break sensor 104 determines whether to become the lead device. In some examples, the glass break sensor 104 self-assigns as the new lead device 115b. For example, the glass break sensor 104 can self-select and self-assign as the new lead device 115b based on attributes of the glass break sensor 104. Attributes can include a network bandwidth, a connectivity level between the glass break sensor 104 and the network 116, a power level of a power supply of the glass break sensor 104, other attributes, or any combination of these.

In some examples, the glass break sensor 104 receives an instruction to become the lead device. The instruction can be received from one or more computers, such as from the monitoring system 110. The instruction can be received from another device of the set of devices 200. For example, the glass break sensor 104 can receive the instruction from the prior lead device 115a (e.g., indoor camera 102) prior to failure of the prior lead device or during failure of the prior lead device. In this example, the indoor camera 102 detects its impending failure and selects a new device of the set of devices 200 as the lead device. The indoor camera 102 can select and assign the glass break sensor 104 as the new lead device based on attributes of the glass break sensor 104. Attributes can include a network bandwidth, a connectivity level between the glass break sensor 104 and the network 116, a power level of a power supply of the glass break sensor 104, other attributes, or any combination of these. In some cases, the indoor camera 102 can compare attributes of the glass break sensor 104 to attributes of other devices of the set of devices 200 in order to select the glass break sensor 104 as the new lead device 115b.

In some examples, the glass break sensor 104 receives the instruction from another device of the set of devices 200 such as the outdoor camera 105. For example, the outdoor camera 105 may detect failure of the indoor camera 102 before the glass break sensor 104 detects failure of the indoor camera 102. The outdoor camera 105 can send a notification of the detected failure of the indoor camera 102 to other devices of the set of devices and can select the glass break sensor 104 as the new lead device 115b. The outdoor camera 105 can send the instruction to the glass break sensor 104 assigning the glass break sensor 104 as the new lead device 115b.

In some cases, a distress signal emitted by the lead device 115a may be detectable by some devices and may be undetectable by other devices. For example, the indoor camera 102 can lose connectivity with the network 116, and in response, emit a visible distress signal. Another camera may detect the visible distress signal and notify other devices of the failure of the indoor camera 102. Meanwhile, devices such as the motion sensor 103 and the smoke detector 101 might be unable to detect the visible distress signal. In some examples, the indoor camera 102 can lose hardwired power and in response, emit an audible distress signal. A device with a microphone (e.g., the glass break sensor 104, the mobile device 106) may detect the audible distress signal and notify other devices of the failure of the indoor camera 102. Meanwhile, devices such as the motion sensor 103 and the smoke detector 101 might be unable to detect the audible distress signal. In some cases, devices that detect failure of the lead device 115a can notify the monitoring system 110 of the failure of the lead device 115a.

In response to determining not to become the lead device, the process 500 includes assigning another device as a new lead device or receiving a notification of assignment of a new lead device (520). For example, another device of the set of devices 200 (e.g., the mobile device 106) can be assigned as the new lead device, and the glass break sensor 104 can receive a notification of the assignment of the other device as the new lead device. The glass break sensor 104 can then send sensor data to the new lead device 115b.

In some examples, the monitoring system 110 notifies the set of devices of the assignment of the new lead device 115b. For example, the glass break sensor 104 can detect failure of the indoor camera 102 and send a notification to the monitoring system 110. The monitoring system 110 can assign the mobile device 106 as the new lead device 115b, and can send notifications to the glass break sensor 104, the motion sensor 103, and the smoke detector 101 indicating that the mobile device 106 is assigned as the new lead device 115b. In this way, the motion sensor 103 and the smoke detector 101 can be informed of the assignment of the new lead device 115b, even though the motion sensor 103 and the smoke detector 101 might not have detected the failure of the indoor camera 102. The motion sensor 103 and the smoke detector 101 can begin transmitting sensor data to the new lead device 115b.

In some instances, the process 500, e.g., the device executing operations from the process 500, can determine to assign the other device as lead device. This might occur when the device determines, using the one or more device attributes, that the other device has more power, more computational resources, or both, and should be assigned as lead device.

In response to determining not to become the lead device, the process 500 includes generating sensor data and sending the sensor data to the new lead device (522). For example, referring to FIG. 4B, the glass break sensor 104 determines to become the new lead device 115b.

In response to determining to become the lead device, the process 500 includes performing a discovery process for the set of devices (510). For example, referring to FIG. 4C, the glass break sensor 104 performs a discovery process for the set of devices 200. The discovery process can include sending a polling message to devices of the set of devices 200. At least some of the devices can respond to the polling message by sending device attribute information 148 about the device. The device attribute information 148 can include, for example, a power level of a power supply of the device, a connectivity level of the device, a bandwidth of the device, or any combination of these. In some examples, the device attribute information 148 can include information about a location of the device. For example, the smoke detector 101 can send information to the glass break sensor 104 indicating that the smoke detector has a battery at 100% power, has a hardwired connection that is providing power, has a connectivity level of 80%, and is located in the kitchen of the property 122.

In some examples, the new lead device 115b collects sensor data that was generated prior to the failure of the prior lead device 115a to determine a predicted cause of failure of the prior lead device 115a. For example, after becoming the new lead device 115b, the glass break sensor 104 can send a request to the other devices of the set of devices 200 for sensor data that was generated prior to failure of the indoor camera 102. The glass break sensor 104 can process the sensor data to determine a predicted cause of failure of the indoor camera 102. In some examples, the glass break sensor 104 sends the collected sensor data to the monitoring system 110, and the monitoring system 110 determines a predicted cause of failure of the indoor camera 102. Example cause of failure can include: loss of power to the property 122 or part of the property 122, a jamming event at the property 122, failure of the network 116, battery power failure of the indoor camera 102, malfunction of the camera 102, other causes of failure, or any combination of these.

After determining the predicted cause of failure of the prior lead device 115a, the new lead device 115b can send information to the monitoring system 110 indicating the predicted cause of the failure. In some examples, the lead device 115b performs actions in response to predicting failure of the first device such as activating an alarm at the property, sending a notification to one or more user devices, or both.

The process 500 includes notifying other devices of the set of devices of becoming the lead device (512). For example, referring to FIG. 4C, the glass break sensor 104 sends notifications 404 to the other devices of the set of devices 200. The notifications 404 indicate that the glass break sensor 104 is assigned as the new lead device 115b. In some examples, the notification sent to the mobile device 106 causes a visual alert to be displayed to the user 107. The alert can inform the user 107 that the prior lead device 115a failed, and that a new lead device 115b has been assigned. In some examples, the alert indicates a predicted cause of the failure of the prior lead device 115a.

The process 500 includes collecting sensor data generated by at least some of the set of devices (514). For example, referring to FIG. 4D, the glass break sensor 104 collects sensor data 406 generated by the smoke detector 101, the outdoor camera 105, the motion sensor 103, and the mobile device 106. Due to failure of the indoor camera 102, the glass break sensor 104 might not receive sensor data generated by the indoor camera 102, e.g., depending on the type of the failure. When the failure is a failure in the ability of the indoor camera 102 to communicate with the monitoring system and the indoor camera 102 can still communicate with the glass break sensor 104, the glass break sensor can receive sensor data generated by the indoor camera 102. In some cases, the glass break sensor 104 periodically sends a test message to the indoor camera 102 to determine when the indoor camera 102 is restored. In some examples, the glass break sensor 104 periodically sends a message to the indoor camera 102 indicating that the glass break sensor 104 is the new lead device 115b. When the indoor camera 102 recovers from its failure, the indoor camera 102 can receive a message from the glass break sensor 104 and begins sending sensor data to the glass break sensor 104. In some examples, when the indoor camera 102 recovers, the indoor camera 102 can be reassigned as the lead device.

The process 500 includes generating event information using the sensor data (516). For example, referring to FIG. 4D, the glass break sensor 104 generates event information 120 using the collected sensor data 406.

The process 500 includes communicating the event information to one or more computers (518). For example, referring to FIG. 4D, the glass break sensor 104 transmits the event information 120 to the monitoring system 110.

The orders of operations in the process 300 and the process 500 described above are illustrative only, and can be performed in different orders. For instance, the process 300 can include one or more of operations 312 to 316 substantially concurrently, in different orders, or both. The process 500 can include one or more of operations 510 to 516 substantially concurrently, in different orders, or both. In some implementations, the process 300, the process 500, or both, can include additional operations, fewer operations, or some of the operations can be divided into multiple operations. For instance, the process 300 can include operations 306, 312, and 312 optionally without one or more of the other operations. The process 500 can include operations 504, 508, and 510 optionally without one or more of the other operations. In some implementations, some processing might be performed on a cloud system in addition to the devices, or a combination of both.

In this specification, the term “database” is used broadly to refer to any collection of data: the data does not need to be structured in any particular way, or structured at all, and it can be stored on storage devices in one or more locations. A database can be implemented on any appropriate type of memory.

In this specification the term “engine” is used broadly to refer to a software-based system, subsystem, or process that is programmed to perform one or more specific functions. Generally, an engine will be implemented as one or more software modules or components, installed on one or more computers in one or more locations. In some instances, one or more computers will be dedicated to a particular engine. In some instances, multiple engines can be installed and running on the same computer or computers. An application can be implemented as an engine or include one or more engines.

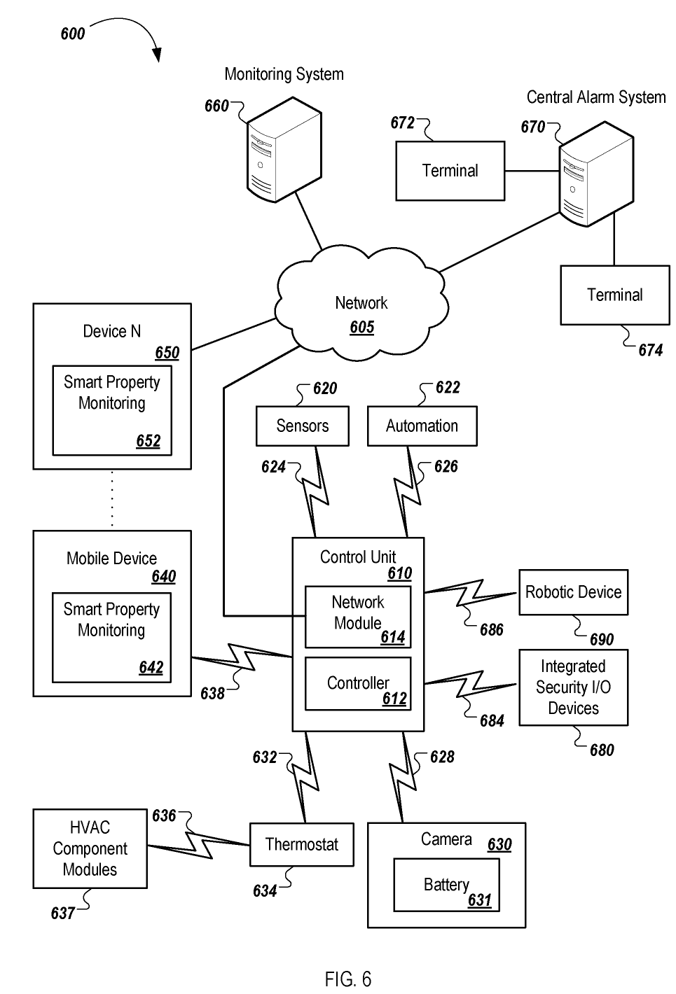

FIG. 6 is a diagram illustrating an example of an environment 600, e.g., for monitoring a property. The property can be any appropriate type of property, such as a home, a business, or a combination of both. The environment 600 includes a network 605, a control unit 610, one or more devices 640 and 650, a monitoring system 660, a central alarm system 670, or a combination of two or more of these. In some examples, the network 605 facilitates communications between two or more of the control unit 610, the one or more devices 640 and 650, the monitoring system 660, and the central alarm system 670.

The network 605 is configured to enable exchange of electronic communications between devices connected to the network 605. For example, the network 605 can be configured to enable exchange of electronic communications between the control unit 610, the one or more devices 640 and 650, the monitoring system 660, and the central alarm system 670. The network 605 can include, for example, one or more of the Internet, Wide Area Networks (“WANs”), Local Area Networks (“LANs”), analog or digital wired and wireless telephone networks (e.g., a public switched telephone network (“PSTN”), Integrated Services Digital Network (“ISDN”), a cellular network, and Digital Subscriber Line (“DSL”)), radio, television, cable, satellite, any other delivery or tunneling mechanism for carrying data, or a combination of these. The network 605 can include multiple networks or subnetworks, each of which can include, for example, a wired or wireless data pathway. The network 605 can include a circuit-switched network, a packet-switched data network, or any other network able to carry electronic communications (e.g., data or voice communications). For example, the network 605 can include networks based on the Internet protocol (“IP”), asynchronous transfer mode (“ATM”), the PSTN, packet-switched networks based on IP, X.25, or Frame Relay, or other comparable technologies and can support voice using, for example, voice over IP (“VoIP”), or other comparable protocols used for voice communications. The network 605 can include one or more networks that include wireless data channels and wireless voice channels. The network 605 can be a broadband network.

The control unit 610 includes a controller 612 and a network module 614. The controller 612 is configured to control a control unit monitoring system, e.g., a control unit system, that includes the control unit 610. In some examples, the controller 612 can include one or more processors or other control circuitry configured to execute instructions of a program that controls operation of a control unit system. In these examples, the controller 612 can be configured to receive input from sensors, or other devices included in the control unit system and control operations of devices at the property, e.g., speakers, displays, lights, doors, other appropriate devices, or a combination of these. For example, the controller 612 can be configured to control operation of the network module 614 included in the control unit 610.

The network module 614 is a communication device configured to exchange communications over the network 605. The network module 614 can be a wireless communication module configured to exchange wireless, wired, or a combination of both, communications over the network 605. For example, the network module 614 can be a wireless communication device configured to exchange communications over a wireless data channel and a wireless voice channel. In some examples, the network module 614 can transmit alarm data over a wireless data channel and establish a two-way voice communication session over a wireless voice channel. The wireless communication device can include one or more of a LTE module, a GSM module, a radio modem, a cellular transmission module, or any type of module configured to exchange communications in any appropriate type of wireless or wired format.

The network module 614 can be a wired communication module configured to exchange communications over the network 605 using a wired connection. For instance, the network module 614 can be a modem, a network interface card, or another type of network interface device. The network module 614 can be an Ethernet network card configured to enable the control unit 610 to communicate over a local area network, the Internet, or a combination of both. The network module 614 can be a voice band modem configured to enable the alarm panel to communicate over the telephone lines of Plain Old Telephone Systems (“POTS”).

The control unit system that includes the control unit 610 can include one or more sensors 620. For example, the environment 600 can include multiple sensors 620. The sensors 620 can include a lock sensor, a contact sensor (e.g., door/window contact sensor), a motion sensor, a camera (e.g., a camera 630), a flow meter, any other type of sensor included in a control unit system, or a combination of two or more of these. The sensors 620 can include an environmental sensor, such as a temperature sensor, a water sensor, a rain sensor, a wind sensor, a light sensor, a smoke detector, a carbon monoxide detector, or an air quality sensor, to name a few additional examples. The sensors 620 can include a health monitoring sensor, such as a prescription bottle sensor that monitors taking of prescriptions, a blood pressure sensor, a blood sugar sensor, or a bed mat configured to sense presence of liquid (e.g., bodily fluids) on the bed mat. In some examples, the health monitoring sensor can be a wearable sensor that attaches to a person, e.g., a user, at the property. The health monitoring sensor can collect various health data, including pulse, heartrate, respiration rate, sugar or glucose level, bodily temperature, motion data, or a combination of these. The sensors 620 can include a radio-frequency identification (“RFID”) sensor that identifies a particular article that includes a pre-assigned RFID tag.

The control unit 610 can communicate with a module 622 and a camera 630 to perform monitoring. The module 622 is connected to one or more devices that enable property automation, e.g., home or business automation. For instance, the module 622 can connect to, and be configured to control operation of, one or more lighting systems. The module 622 can connect to, and be configured to control operation of, one or more electronic locks, e.g., control Z-Wave locks using wireless communications in the Z-Wave protocol. In some examples, the module 622 can connect to, and be configured to control operation of, one or more appliances. The module 622 can include multiple sub-modules that are each specific to a type of device being controlled in an automated manner. The module 622 can control the one or more devices using commands received from the control unit 610. For instance, the module 622 can receive a command from the control unit 610, which command was sent using data captured by the camera 630 that depicts an area. In response, the module 622 can cause a lighting system to illuminate an area to provide better lighting in the area, and a higher likelihood that the camera 630 can capture a subsequent image of the area that depicts more accurate data of the area.

The camera 630 can be an image camera or other type of optical sensing device configured to capture one or more images. For instance, the camera 630 can be configured to capture images of an area within a property monitored by the control unit 610. The camera 630 can be configured to capture single, static images of the area; video of the area, e.g., a sequence of images; or a combination of both. The sequence of images can be a sequence of frames, e.g., when the video is compressed using a video codec. The image captured by the camera can be any appropriate type of image, e.g., a frame. The camera 630 can be controlled using commands received from the control unit 610 or another device in the property monitoring system, e.g., a device 650.

The camera 630 can be triggered using any appropriate techniques, can capture images continuously, or a combination of both. For instance, a Passive Infra-Red (“PIR”) motion sensor can be built into the camera 630 and used to trigger the camera 630 to capture one or more images when motion is detected. The camera 630 can include a microwave motion sensor built into the camera which is used to trigger the camera 630 to capture one or more images when motion is detected. The camera 630 can have a “normally open” or “normally closed” digital input that can trigger capture of one or more images when external sensors detect motion or other events. The external sensors can include another sensor from the sensors 620, PIR, or door or window sensors, to name a few examples. In some implementations, the camera 630 receives a command to capture an image, e.g., when external devices detect motion or another potential alarm event or in response to a request from a device. The camera 630 can receive the command from the controller 612, directly from one of the sensors 620, or a combination of both.

In some examples, the camera 630 triggers integrated or external illuminators to improve image quality when the scene is dark. Some examples of illuminators can include Infra-Red, Z-wave controlled “white” lights, lights controlled by the module 622, or a combination of these. An integrated or separate light sensor can be used to determine if illumination is desired and can result in increased image quality.

The camera 630 can be programmed with any combination of time schedule, day schedule, system “arming state”, other variables, or a combination of these, to determine whether images should be captured when one or more triggers occur. The camera 630 can enter a low-power mode when not capturing images. In this case, the camera 630 can wake periodically to check for inbound messages from the controller 612 or another device. The camera 630 can be powered by internal, replaceable batteries, e.g., if located remotely from the control unit 610. The camera 630 can employ a small solar cell to recharge the battery when light is available. The camera 630 can be powered by a wired power supply, e.g., the controller’s 612 power supply if the camera 630 is co-located with the controller 612.

In some implementations, the camera 630 communicates directly with the monitoring system 660 over the network 605. In these implementations, image data captured by the camera 630 need not pass through the control unit 610. The camera 630 can receive commands related to operation from the monitoring system 660, provide images to the monitoring system 660, or a combination of both.

The environment 600 can include one or more thermostats 634, e.g., to perform dynamic environmental control at the property. The thermostat 634 is configured to monitor temperature of the property, energy consumption of a heating, ventilation, and air conditioning (“HVAC”) system associated with the thermostat 634, or both. In some examples, the thermostat 634 is configured to provide control of environmental (e.g., temperature) settings. In some implementations, the thermostat 634 can additionally or alternatively receive data relating to activity at a property; environmental data at a property, e.g., at various locations indoors or outdoors or both at the property; or a combination of both. The thermostat 634 can measure or estimate energy consumption of the HVAC system associated with the thermostat. The thermostat 634 can estimate energy consumption, for example, using data that indicates usage of one or more components of the HVAC system associated with the thermostat 634. The thermostat 634 can communicate various data, e.g., temperature, energy, or both, with the control unit 610. In some examples, the thermostat 634 can control the environment, e.g., temperature, settings in response to commands received from the control unit 610.

In some implementations, the thermostat 634 is a dynamically programmable thermostat and can be integrated with the control unit 610. For example, the dynamically programmable thermostat 634 can include the control unit 610, e.g., as an internal component to the dynamically programmable thermostat 634. In some examples, the control unit 610 can be a gateway device that communicates with the dynamically programmable thermostat 634. In some implementations, the thermostat 634 is controlled via one or more modules 622.

The environment 600 can include the HVAC system or otherwise be connected to the HVAC system. For instance, the environment 600 can include one or more HVAC modules 637. The HVAC modules 637 can be connected to one or more components of the HVAC system associated with a property. A module 637 can be configured to capture sensor data from, control operation of, or both, corresponding components of the HVAC system. In some implementations, the module 637 is configured to monitor energy consumption of an HVAC system component, for example, by directly measuring the energy consumption of the HVAC system components or by estimating the energy usage of the one or more HVAC system components by detecting usage of components of the HVAC system. The module 637 can communicate energy monitoring information, the state of the HVAC system components, or both, to the thermostat 634. The module 637 can control the one or more components of the HVAC system in response to receipt of commands received from the thermostat 634.

In some examples, the environment 600 includes one or more robotic devices 690. The robotic devices 690 can be any type of robots that are capable of moving, such as an aerial drone, a land-based robot, or a combination of both. The robotic devices 690 can take actions, such as capture sensor data or other actions that assist in security monitoring, property automation, or a combination of both. For example, the robotic devices 690 can include robots capable of moving throughout a property using automated navigation control technology, user input control provided by a user, or a combination of both. The robotic devices 690 can fly, roll, walk, or otherwise move about the property. The robotic devices 690 can include helicopter type devices (e.g., quad copters), rolling helicopter type devices (e.g., roller copter devices that can fly and roll along the ground, walls, or ceiling) and land vehicle type devices (e.g., automated cars that drive around a property). In some examples, the robotic devices 690 can be robotic devices 690 that are intended for other purposes and merely associated with the environment 600 for use in appropriate circumstances. For instance, a robotic vacuum cleaner device can be associated with the environment 600 as one of the robotic devices 690 and can be controlled to take action responsive to monitoring system events.

In some examples, the robotic devices 690 automatically navigate within a property. In these examples, the robotic devices 690 include sensors and control processors that guide movement of the robotic devices 690 within the property. For instance, the robotic devices 690 can navigate within the property using one or more cameras, one or more proximity sensors, one or more gyroscopes, one or more accelerometers, one or more magnetometers, a global positioning system (“GPS”) unit, an altimeter, one or more sonar or laser sensors, any other types of sensors that aid in navigation about a space, or a combination of these. The robotic devices 690 can include control processors that process output from the various sensors and control the robotic devices 690 to move along a path that reaches the desired destination, avoids obstacles, or a combination of both. In this regard, the control processors detect walls or other obstacles in the property and guide movement of the robotic devices 690 in a manner that avoids the walls and other obstacles.

In some implementations, the robotic devices 690 can store data that describes attributes of the property. For instance, the robotic devices 690 can store a floorplan, a three-dimensional model of the property, or a combination of both, that enable the robotic devices 690 to navigate the property. During initial configuration, the robotic devices 690 can receive the data describing attributes of the property, determine a frame of reference to the data (e.g., a property or reference location in the property), and navigate the property using the frame of reference and the data describing attributes of the property. In some examples, initial configuration of the robotic devices 690 can include learning one or more navigation patterns in which a user provides input to control the robotic devices 690 to perform a specific navigation action (e.g., fly to an upstairs bedroom and spin around while capturing video and then return to a property charging base). In this regard, the robotic devices 690 can learn and store the navigation patterns such that the robotic devices 690 can automatically repeat the specific navigation actions upon a later request.

In some examples, the robotic devices 690 can include data capture devices. In these examples, the robotic devices 690 can include, as data capture devices, one or more cameras, one or more motion sensors, one or more microphones, one or more biometric data collection tools, one or more temperature sensors, one or more humidity sensors, one or more air flow sensors, any other type of sensor that can be useful in capturing monitoring data related to the property and users in the property, or a combination of these. The one or more biometric data collection tools can be configured to collect biometric samples of a person in the property with or without contact of the person. For instance, the biometric data collection tools can include a fingerprint scanner, a hair sample collection tool, a skin cell collection tool, or any other tool that allows the robotic devices 690 to take and store a biometric sample that can be used to identify the person (e.g., a biometric sample with DNA that can be used for DNA testing).

In some implementations, the robotic devices 690 can include output devices. In these implementations, the robotic devices 690 can include one or more displays, one or more speakers, any other type of output devices that allow the robotic devices 690 to communicate information, e.g., to a nearby user or another type of person, or a combination of these.

The robotic devices 690 can include a communication module that enables the robotic devices 690 to communicate with the control unit 610, each other, other devices, or a combination of these. The communication module can be a wireless communication module that allows the robotic devices 690 to communicate wirelessly. For instance, the communication module can be a Wi-Fi module that enables the robotic devices 690 to communicate over a local wireless network at the property. Other types of short-range wireless communication protocols, such as 900 MHz wireless communication, Bluetooth, Bluetooth LE, Z-wave, Zigbee, Matter, or any other appropriate type of wireless communication, can be used to allow the robotic devices 690 to communicate with other devices, e.g., in or off the property. In some implementations, the robotic devices 690 can communicate with each other or with other devices of the environment 600 through the network 605.

The robotic devices 690 can include processor and storage capabilities. The robotic devices 690 can include any one or more suitable processing devices that enable the robotic devices 690 to execute instructions, operate applications, perform the actions described throughout this specification, or a combination of these. In some examples, the robotic devices 690 can include solid-state electronic storage that enables the robotic devices 690 to store applications, configuration data, collected sensor data, any other type of information available to the robotic devices 690, or a combination of two or more of these.

The robotic devices 690 can process captured data locally, provide captured data to one or more other devices for processing, e.g., the control unit 610 or the monitoring system 660, or a combination of both. For instance, the robotic device 690 can provide the images to the control unit 610 for processing. In some examples, the robotic device 690 can process the images to determine an identification of the items.

One or more of the robotic devices 690 can be associated with one or more charging stations. The charging stations can be located at a predefined home base or reference location in the property. The robotic devices 690 can be configured to navigate to one of the charging stations after completion of one or more tasks needed to be performed, e.g., for the environment 600. For instance, after completion of a monitoring operation or upon instruction by the control unit 610, a robotic device 690 can be configured to automatically fly to and connect with, e.g., land on, one of the charging stations. In this regard, a robotic device 690 can automatically recharge one or more batteries included in the robotic device 690 so that the robotic device 690 is less likely to need recharging when the environment 600 requires use of the robotic device 690, e.g., absent other concerns for the robotic device 690.

The charging stations can be contact-based charging stations, wireless charging stations, or a combination of both. For contact-based charging stations, the robotic devices 690 can have readily accessible points of contact to which a robotic device 690 can contact on the charging station. For instance, a helicopter type robotic device can have an electronic contact on a portion of its landing gear that rests on and couples with an electronic pad of a charging station when the helicopter type robotic device lands on the charging station. The electronic contact on the robotic device 690 can include a cover that opens to expose the electronic contact when the robotic device is charging and closes to cover and insulate the electronic contact when the robotic device 690 is in operation.

For wireless charging stations, the robotic devices 690 can charge through a wireless exchange of power. In these instances, a robotic device 690 needs only position itself closely enough to a wireless charging station for the wireless exchange of power to occur. In this regard, the positioning needed to land at a predefined home base or reference location in the property can be less precise than with a contact-based charging station. Based on the robotic devices 690 landing at a wireless charging station, the wireless charging station can output a wireless signal that the robotic device 690 receives and converts to a power signal that charges a battery maintained on the robotic device 690. As described in this specification, a robotic device 690 landing or coupling with a charging station can include a robotic device 690 positioning itself within a threshold distance of a wireless charging station such that the robotic device 690 is able to charge its battery.

In some implementations, one or more of the robotic devices 690 has an assigned charging station. In these implementations, the number of robotic devices 690 can equal the number of charging stations. In these implementations, the robotic devices 690 can always navigate to the specific charging station assigned to that robotic device 690. For instance, a first robotic device can always use a first charging station and a second robotic device can always use a second charging station.

In some examples, the robotic devices 690 can share charging stations. For instance, the robotic devices 690 can use one or more community charging stations that are capable of charging multiple robotic devices 690, e.g., substantially concurrently or separately or a combination of both at different times. The community charging station can be configured to charge multiple robotic devices 690 at substantially the same time, e.g., the community charging station can begin charging a first robotic device and then, while charging the first robotic device, begin charging a second robotic device five minutes later. The community charging station can be configured to charge multiple robotic devices 690 in serial such that the multiple robotic devices 690 take turns charging and, when fully charged, return to a predefined home base or reference location or another location in the property that is not associated with a charging station. The number of community charging stations can be less than the number of robotic devices 690.

In some instances, the charging stations might not be assigned to specific robotic devices 690 and can be capable of charging any of the robotic devices 690. In this regard, the robotic devices 690 can use any suitable, unoccupied charging station when not in use, e.g., when not performing an operation for the environment 600. For instance, when one of the robotic devices 690 has completed an operation or is in need of battery charge, the control unit 610 can reference a stored table of the occupancy status of each charging station and instructs the robotic device to navigate to the nearest charging station that has at least one unoccupied charger.

The environment 600 can include one or more integrated security devices 680. The one or more integrated security devices can include any type of device used to provide alerts based on received sensor data. For instance, the one or more control units 610 can provide one or more alerts to the one or more integrated security input/output devices 680. In some examples, the one or more control units 610 can receive sensor data from the sensors 620 and determine whether to provide an alert, or a message to cause presentation of an alert, to the one or more integrated security input/output devices 680.

The sensors 620, the module 622, the camera 630, the thermostat 634, the module 637, the integrated security devices 680, and the robotic devices 690, can communicate with the controller 612 over communication links 624, 626, 628, 632, 636, 638, 684, and 686. The communication links 624, 626, 628, 632, 636, 638, 684, and 686 can be a wired or wireless data pathway configured to transmit signals between any combination of the sensors 620, the module 622, the camera 630, the thermostat 634, the module 637, the integrated security devices 680, the robotic devices 690, or the controller 612. The sensors 620, the module 622, the camera 630, the thermostat 634, the module 637, the integrated security devices 680, and the robotic devices 690, can continuously transmit sensed values to the controller 612, periodically transmit sensed values to the controller 612, or transmit sensed values to the controller 612 in response to a change in a sensed value, a request, or both. In some implementations, the robotic devices 690 can communicate with the monitoring system 660 over network 605. The robotic devices 690 can connect and communicate with the monitoring system 660 using a Wi-Fi or a cellular connection or any other appropriate type of connection.

The communication links 624, 626, 628, 632, 636, 638, 684, and 686 can include any appropriate type of network, such as a local network. The sensors 620, the module 622, the camera 630, the thermostat 634, the robotic devices 690 and the integrated security devices 680, and the controller 612 can exchange data and commands over the network.

The monitoring system 660 can include one or more electronic devices, e.g., one or more computers. The monitoring system 660 is configured to provide monitoring services by exchanging electronic communications with the control unit 610, the one or more devices 640 and 650, the central alarm system 670, or a combination of these, over the network 605. For example, the monitoring system 660 can be configured to monitor events (e.g., alarm events) generated by the control unit 610. In these examples, the monitoring system 660 can exchange electronic communications with the network module 614 included in the control unit 610 to receive information regarding events (e.g., alerts) detected by the control unit 610. The monitoring system 660 can receive information regarding events (e.g., alerts) from the one or more devices 640 and 650.

In some implementations, the monitoring system 660 might be configured to provide one or more services other than monitoring services. In these implementations, the monitoring system 660 might perform one or more operations described in this specification without providing any monitoring services, e.g., the monitoring system 660 might not be a monitoring system as described in the example shown in FIG. 6.

In some examples, the monitoring system 660 can route alert data received from the network module 614 or the one or more devices 640 and 650 to the central alarm system 670. For example, the monitoring system 660 can transmit the alert data to the central alarm system 670 over the network 605.

The monitoring system 660 can store sensor and image data received from the environment 600 and perform analysis of sensor and image data received from the environment 600. Based on the analysis, the monitoring system 660 can communicate with and control aspects of the control unit 610 or the one or more devices 640 and 650.

The monitoring system 660 can provide various monitoring services to the environment 600. For example, the monitoring system 660 can analyze the sensor, image, and other data to determine an activity pattern of a person of the property monitored by the environment 600. In some implementations, the monitoring system 660 can analyze the data for alarm conditions or can determine and perform actions at the property by issuing commands to one or more components of the environment 600, possibly through the control unit 610.

The central alarm system 670 is an electronic device, or multiple electronic devices, configured to provide alarm monitoring service by exchanging communications with the control unit 610, the one or more mobile devices 640 and 650, the monitoring system 660, or a combination of these, over the network 605. For example, the central alarm system 670 can be configured to monitor alerting events generated by the control unit 610. In these examples, the central alarm system 670 can exchange communications with the network module 614 included in the control unit 610 to receive information regarding alerting events detected by the control unit 610. The central alarm system 670 can receive information regarding alerting events from the one or more mobile devices 640 and 650, the monitoring system 660, or both. In some implementations, the central alarm system 670 can be implemented, at least in part if not entirely, on the monitoring system 660. In these implementations, the monitoring system 660 can perform the operations described with reference to the central alarm system 670. One or both of the monitoring system 660 or the central alarm system 670 can be implemented in the cloud.

The central alarm system 670 is connected to multiple terminals 672 and 674. The terminals 672 and 674 can be used by operators to process alerting events. For example, the central alarm system 670, e.g., as part of a first responder system, can route alerting data to the terminals 672 and 674 to enable an operator to process the alerting data. The terminals 672 and 674 can include general-purpose computers (e.g., desktop personal computers, workstations, or laptop computers) that are configured to receive alerting data from a computer in the central alarm system 670 and render a display of information using the alerting data.

For instance, the controller 612 can control the network module 614 to transmit, to the central alarm system 670, alerting data indicating that a sensor 620 detected motion from a motion sensor via the sensors 620. The central alarm system 670 can receive the alerting data and route the alerting data to the terminal 672 for processing by an operator associated with the terminal 672. The terminal 672 can render a display to the operator that includes information associated with the alerting event (e.g., the lock sensor data, the motion sensor data, the contact sensor data, etc.) and the operator can handle the alerting event based on the displayed information. In some implementations, the terminals 672 and 674 can be mobile devices or devices designed for a specific function. Although FIG. 6 illustrates two terminals for brevity, actual implementations can include more (and, perhaps, many more) terminals.

The one or more devices 640 and 650 are devices that can present content, e.g., host and display user interfaces, audio data, or both. For instance, the mobile device 640 is a mobile device that hosts or runs one or more native applications (e.g., the smart property application 642). The mobile device 640 can be a cellular phone or a non-cellular locally networked device with a display. The mobile device 640 can include a cell phone, a smart phone, a tablet PC, a personal digital assistant (“PDA”), or any other portable device configured to communicate over a network and present information. The mobile device 640 can perform functions unrelated to the monitoring system, such as placing personal telephone calls, playing music, playing video, displaying pictures, browsing the Internet, and maintaining an electronic calendar.

The mobile device 640 can include a smart property application 642. The smart property application 642 refers to a software/firmware program running on the corresponding mobile device that enables the user interface and features described throughout. The mobile device 640 can load or install the smart property application 642 using data received over a network or data received from local media. The smart property application 642 enables the mobile device 640 to receive and process image and sensor data from the monitoring system 660.

The device 650 can be a general-purpose computer (e.g., a desktop personal computer, a workstation, or a laptop computer) that is configured to communicate with the monitoring system 660, the control unit 610, or both, over the network 605. The device 650 can be configured to display a smart property user interface 652 that is generated by the device 650 or generated by the monitoring system 660. For example, the device 650 can be configured to display a user interface (e.g., a web page) generated using data provided by the monitoring system 660 that enables a user to perceive images captured by the camera 630, reports related to the monitoring system, or both. Although FIG. 6 illustrates two devices for brevity, actual implementations can include more (and, perhaps, many more) or fewer devices.

In some implementations, the one or more devices 640 and 650 communicate with and receive data from the control unit 610 using the communication link 638. For instance, the one or more devices 640 and 650 can communicate with the control unit 610 using various wireless protocols, or wired protocols such as Ethernet and USB, to connect the one or more devices 640 and 650 to the control unit 610, e.g., local security and automation equipment. The one or more devices 640 and 650 can use a local network, a wide area network, or a combination of both, to communicate with other components in the environment 600. The one or more devices 640 and 650 can connect locally to the sensors and other devices in the environment 600.

Although the one or more devices 640 and 650 are shown as communicating with the control unit 610, the one or more devices 640 and 650 can communicate directly with the sensors and other devices controlled by the control unit 610. In some implementations, the one or more devices 640 and 650 replace the control unit 610 and perform one or more of the functions of the control unit 610 for local monitoring and long range, offsite, or both, communication.

In some implementations, the one or more devices 640 and 650 receive monitoring system data captured by the control unit 610 through the network 605. The one or more devices 640 and 650 can receive the data from the control unit 610 through the network 605, the monitoring system 660 can relay data received from the control unit 610 to the one or more devices 640 and 650 through the network 605, or a combination of both. In this regard, the monitoring system 660 can facilitate communication between the one or more devices 640 and 650 and various other components in the environment 600.

In some implementations, the one or more devices 640 and 650 can be configured to switch whether the one or more devices 640 and 650 communicate with the control unit 610 directly (e.g., through communication link 638) or through the monitoring system 660 (e.g., through network 605) based on a location of the one or more devices 640 and 650. For instance, when the one or more devices 640 and 650 are located close to, e.g., within a threshold distance of, the control unit 610 and in range to communicate directly with the control unit 610, the one or more devices 640 and 650 use direct communication. When the one or more devices 640 and 650 are located far from, e.g., outside the threshold distance of, the control unit 610 and not in range to communicate directly with the control unit 610, the one or more devices 640 and 650 use communication through the monitoring system 660.

Although the one or more devices 640 and 650 are shown as being connected to the network 605, in some implementations, the one or more devices 640 and 650 are not connected to the network 605. In these implementations, the one or more devices 640 and 650 communicate directly with one or more of the monitoring system components and no network (e.g., Internet) connection or reliance on remote servers is needed.

In some implementations, the one or more devices 640 and 650 are used in conjunction with only local sensors and/or local devices in a house. In these implementations, the environment 600 includes the one or more devices 640 and 650, the sensors 620, the module 622, the camera 630, and the robotic devices 690. The one or more devices 640 and 650 receive data directly from the sensors 620, the module 622, the camera 630, the robotic devices 690, or a combination of these, and send data directly to the sensors 620, the module 622, the camera 630, the robotic devices 690, or a combination of these. The one or more devices 640 and 650 can provide the appropriate interface, processing, or both, to provide visual surveillance and reporting using data received from the various other components.

In some implementations, the environment 600 includes network 605 and the sensors 620, the module 622, the camera 630, the thermostat 634, and the robotic devices 690 are configured to communicate sensor and image data to the one or more devices 640 and 650 over network 605. In some implementations, the sensors 620, the module 622, the camera 630, the thermostat 634, and the robotic devices 690 are programmed, e.g., intelligent enough, to change the communication pathway from a direct local pathway when the one or more devices 640 and 650 are in close physical proximity to the sensors 620, the module 622, the camera 630, the thermostat 634, the robotic devices 690, or a combination of these, to a pathway over network 605 when the one or more devices 640 and 650 are farther from the sensors 620, the module 622, the camera 630, the thermostat 634, the robotic devices 690, or a combination of these.

In some examples, the monitoring system 660 leverages GPS information from the one or more devices 640 and 650 to determine whether the one or more devices 640 and 650 are close enough to the sensors 620, the module 622, the camera 630, the thermostat 634, the robotic devices 690, or a combination of these, to use the direct local pathway or whether the one or more devices 640 and 650 are far enough from the sensors 620, the module 622, the camera 630, the thermostat 634, the robotic devices 690, or a combination of these, that the pathway over network 605 is required. In some examples, the monitoring system 660 leverages status communications (e.g., pinging) between the one or more devices 640 and 650 and the sensors 620, the module 622, the camera 630, the thermostat 634, the robotic devices 690, or a combination of these, to determine whether communication using the direct local pathway is possible. If communication using the direct local pathway is possible, the one or more devices 640 and 650 communicate with the sensors 620, the module 622, the camera 630, the thermostat 634, the robotic devices 690, or a combination of these, using the direct local pathway. If communication using the direct local pathway is not possible, the one or more devices 640 and 650 communicate with the sensors 620, the module 622, the camera 630, the thermostat 634, the robotic devices 690, or a combination of these, using the pathway over network 605.

In some implementations, the environment 600 provides people with access to images captured by the camera 630 to aid in decision-making. The environment 600 can transmit the images captured by the camera 630 over a network, e.g., a wireless WAN, to the devices 640 and 650. Because transmission over a network can be relatively expensive, the environment 600 can use several techniques to reduce costs while providing access to significant levels of useful visual information (e.g., compressing data, down-sampling data, sending data only over inexpensive LAN connections, or other techniques).

In some implementations, a state of the environment 600, one or more components in the environment 600, and other events sensed by a component in the environment 600 can be used to enable/disable video/image recording devices (e.g., the camera 630). In these implementations, the camera 630 can be set to capture images on a periodic basis when the alarm system is armed in an “away” state, set not to capture images when the alarm system is armed in a “stay” state or disarmed, or a combination of both. In some examples, the camera 630 can be triggered to begin capturing images when the control unit 610 detects an event, such as an alarm event, a door-opening event for a door that leads to an area within a field of view of the camera 630, or motion in the area within the field of view of the camera 630. In some implementations, the camera 630 can capture images continuously, but the captured images can be stored or transmitted over a network when needed.

In some implementations, when a device or system transmits data to another device or system, the transmission of the data, such as a message, can cause the other device or system to perform one or more actions. For instance, transmission of a message that includes an instruction to a camera can cause the camera to capture one or more images, transmit one or more images to the device or system, or a combination of both.

Although FIG. 6 depicts the monitoring system 660 as remote from the control unit 610, in some examples the control unit 610 can be a component of the monitoring system 660. For instance, both the monitoring system 660 and the control unit 610 can be physically located at a property that includes the sensors 620 or at a location outside the property.

In some examples, some of the sensors 620, the robotic devices 690, or a combination of both, might not be directly associated with the property. For instance, a sensor or a robotic device might be located at an adjacent property or on a vehicle that passes by the property. A system at the adjacent property or for the vehicle, e.g., that is in communication with the vehicle or the robotic device, can provide data from that sensor or robotic device to the control unit 610, the monitoring system 660, or a combination of both.

A number of implementations have been described. Nevertheless, it will be understood that various modifications can be made without departing from the spirit and scope of the disclosure. For example, various forms of the flows shown above can be used, with operations re-ordered, added, or removed.

Implementations of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Implementations of the subject matter described in this specification can be implemented as one or more computer programs, i.e., one or more modules of computer program instructions encoded on a tangible non-transitory program carrier for execution by, or to control the operation of, a data processing apparatus. Alternatively or in addition, the program instructions can be encoded on an artificially-generated propagated signal, e.g., a machine-generated electrical, optical, or electromagnetic signal, that is generated to encode information for transmission to a suitable receiver apparatus for execution by a data processing apparatus. One or more computer storage media can include a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including by way of example a programmable processor, a computer, or multiple processors or computers. The apparatus can be or include special purpose logic circuitry, e.g., a field programmable gate array (“FPGA”) or an application-specific integrated circuit (“ASIC”). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can be performed by, and apparatus can also be implemented as, special purpose logic circuitry, e.g., a field programmable gate array (“FPGA”) or an application-specific integrated circuit (“ASIC”).

Computers suitable for the execution of a computer program include, by way of example, general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. A computer can be embedded in another device, e.g., a mobile telephone, a smart phone, a headset, a personal digital assistant (“PDA”), a mobile audio or video player, a game console, a Global Positioning System (“GPS”) receiver, or a portable storage device, e.g., a universal serial bus (“USB”) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a liquid crystal display (“LCD”), an organic light emitting diode (“OLED”) or other monitor, for displaying information to the user and a keyboard and a pointing device, e.g., a mouse or a trackball or a touchscreen, by which the user can provide input to the computer. Other kinds of devices can be used to provide for interaction with a user as well. For example, feedback provided to the user can be any form of sensory feedback, e.g., visual feedback, auditory feedback, or tactile feedback; and input from the user can be received in any form, including acoustic, speech, or tactile input. In some examples, a computer can interact with a user by sending documents to and receiving documents from a device that is used by the user; for example, by sending web pages to a web browser on a user’s device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other. In some implementations, a server transmits data, e.g., an Hypertext Markup Language (“HTML”) page, to a user device, e.g., for purposes of displaying data to and receiving user input from a user device, which acts as a client. Data generated at the user device, e.g., a result of user interaction with the user device, can be received from the user device at the server.

While this specification contains many specific implementation details, these should not be construed as limitations on the scope of what may be claimed, but rather as descriptions of features that may be specific to particular implementations. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some instances be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

Particular implementations of the invention have been described. Other implementations are within the scope of the following claims. For example, the operations recited in the claims, described in the specification, or depicted in the figures can be performed in a different order and still achieve desirable results. In some implementations, multitasking and parallel processing may be advantageous.

1. A computer-implemented method comprising:
maintaining a first device of a set of devices for a property as a lead device, wherein maintaining the first device as the lead device causes the first device to:
collect sensor data generated by the set of devices;
generate event information using the sensor data; and
communicate the event information to one or more computers;
while maintaining the first device as the lead device, detecting a failure of the first device;
selecting, from the set of devices excluding the first device, a second device; and
assigning the second device as the lead device.

2. The method of claim 1, wherein detecting the failure of the first device comprises determining that communication capabilities between the first device and at least one of the one or more computers do not satisfy one or more capability criteria.

3. The method of claim 2, comprising determining that communication capabilities between the first device and the one or more computers do not satisfy the one or more capability criteria based on (i) lack of receipt of communication from the first device or (ii) failure of a test communication.

4. The method of claim 1, comprising detecting the failure of the first device based on (i) receiving a communication from another device of the set of devices indicating failure of the first device or (ii) detecting a distress signal from the first device.

5. The method of claim 1, comprising notifying the other devices of the assignment of the second device as the lead device.

6. The method of claim 1, wherein each device in the set of devices includes a sensing component, a communication component, and a processing component.

7. The method of claim 6, wherein the processing component of at least some devices from the set of devices can execute a security application that can analyze sensor data from a plurality of different types of sensors.

8. The method of claim 6, wherein the sensing component comprises a camera, a motion detector, a smoke detector, a proximity detector, or a contact detector.

9. The method of claim 1, wherein the set of devices communicate with each other through one or more wireless communication protocols.

10. The method of claim 1, wherein maintaining the first device as the lead device comprises sending an instruction to the first device to cause the first device to collect and process the sensor data from other devices in the set of devices.

11. The method of claim 1, comprising selecting the second device using one or more of:
a predetermined hierarchy of devices or device types;
information indicating a connectivity level of the second device and connectivity levels of other devices of the set of devices; or
information indicating a power level of the second device and power levels of other devices of the set of devices.

12. A computer-implemented method comprising:
transmitting, to a first device of a set of devices for a property and from a second device of the set of devices, sensor data generated by the second device, wherein the first device is a lead device of the set of devices;
determining, by the second device, to become the lead device of the set of devices based on a predicted failure of the first device; and
in response to determining to become the lead device of the set of devices based on the predicted failure of the first device, configuring, by the second device, the second device as the lead device to cause the second device to:
collect sensor data generated by at least some of the set of devices;
generate event information using the sensor data; and
communicate the event information to one or more computers.

13. The method of claim 12, wherein determining to become the lead device of the set of devices comprises:
detecting the predicted failure of the first device; and
self-assigning the second device as the lead device.

14. The method of claim 12, wherein determining to become the lead device of the set of devices comprises receiving an instruction to become the lead device, wherein the instruction is received from (i) one or more computers or (ii) another device of the set of devices.

15. The method of claim 12, comprising:
collecting the sensor data generated by the at least some of the set of devices;
generating the event information using the sensor data; and
communicating the event information using the sensor data.

16. The method of claim 12, comprising detecting the predicted failure of the first device by determining that communication capabilities between the first device and the second device do not satisfy one or more capability criteria based on one or more of:
lack of receipt of communication from the first device;
failure of a test communication;
receiving a communication from another device of the set of devices indicating failure of the first device;
detecting a distress signal from the first device;
determining that a bandwidth available for the first device does not satisfy a threshold bandwidth; or
predicting that the first device lost power.

17. The method of claim 12, comprising:
collecting sensor data that was generated prior to failure of the first device;
determining a predicted cause of the failure of the first device; and
sending information indicating the predicted cause of the failure of the first device to the one or more computers.

18. The method of claim 12, comprising transmitting a notification to at least some devices of the set of devices notifying the devices of the second device becoming the lead device in response to determining to become the lead device of the set of devices based on the predicted failure of the first device.

19. The method of claim 12, comprising determining, by the second device, to become the lead device of the set of devices using one or more of:
data indicating one or more attributes of the second device;
a predetermined hierarchy of devices or device types;
information indicating a connectivity level of the second device and connectivity levels of other devices of the set of devices; or
information indicating a power level of the second device and power levels of other devices of the set of devices.

20. One or more computer storage media encoded with instructions that, when executed by one or more computers, cause the one or more computers to perform operations comprising:
maintaining a first device of a set of devices for a property as a lead device, wherein maintaining the first device as the lead device causes the first device to:
collect sensor data generated by the set of devices;
generate event information using the sensor data; and
communicate the event information to one or more computers;
while maintaining the first device as the lead device, detecting a failure of the first device;
selecting, from the set of devices excluding the first device, a second device; and
assigning the second device as the lead device.
